(19) United States
(12) Patent Application Publication
(10) Pub. No.: US 2026/0075067 A1
(43) Pub. Date: Mar. 12, 2026

(54) Converting Feedback to a Structured Representation for Adaptive AI Agent Learning

(71) Applicant: Culminate, Inc., Palo Alto, CA (US)

(72) Inventors: Zicun Cong, Vancouver (CA); Chi Zhang, Foster City, CA (US); Dianhuan Lin, Palo Alto, CA (US); Xiaofei Guo, Palo Alto, CA (US)

(73) Assignee: Culminate, Inc., Palo Alto, CA (US)

(21) Appl. No.: 19/355,205

(22) Filed: Oct. 10, 2025

Related U.S. Application Data
(63) Continuation-in-part of application No. 18/826,337, filed on Sep. 6, 2024.

(51) Int. Cl. H04L 9/40; G06N 5/022

(52) U.S. Cl. CPC H04L 63/1416; G06N 5/022

(57) ABSTRACT

Systems and methods are provided for enabling adaptive modifications to AI agents using human feedback, particularly in the context of investigating cybersecurity alerts. According to one implementation, a method includes a step of receiving feedback from a human analyst related to results of a task performed by an Artificial Intelligence (AI) agent. The method can include a step of converting the feedback into a structured representation having nodes and edges. Furthermore, the method includes a step of updating a knowledge database associated with the AI agent using the structured representation. Next, the method includes a step of utilizing the structured representation and/or knowledge database to improve performance of the AI agent with respect to subsequent tasks.

### CROSS-REFERENCE TO RELATED APPLICATION

The present application is a Continuation-in-Part (CIP) of patent application Ser. No. 18/826,337, filed Sep. 6, 2024, entitled “Automatically investigating security alerts for Security Operations Center (SOC),” the contents of which are incorporated by reference herein.

### TECHNICAL FIELD

The present disclosure generally relates to compute domains, such as compute, network, cloud, Single Sign-On (SSO), security data lake, and any other system that can generate alerts and logs. More particularly, the present disclosure relates to a Security Operations Center (SOC) configured to automatically investigate security alerts from data logs obtained in compute domains using Machine Learning (ML) and Artificial Intelligence (AI) techniques.

### BACKGROUND

Cyber security attacks are responsible for disrupting normal business flow and creating a significant financial burden for many companies. Various tools are available for detecting and responding to different types of security threats to mitigate the negative impacts that attacks can have on an organization. Generally, a Security Operations Center (SOC) normally focuses on security operations and security device management. In addition, a SOC may also perform threat and vulnerability management, compute domain monitoring, and incident reporting. Usually, a SOC includes security software as well as a team of security experts. In the field of security management, Security Information and Event Management (SIEM) is a technology that involves a standardized consumption of log data from multiple security tools throughout compute domains to monitor security threats. Generally, examining log data to determine threats, vulnerabilities, remediation, etc. is a complex task, requiring domain expertise. This problem is further exacerbated with cloud logs which tend to be more complex as well as dependent on the cloud provider. As cyber security is critical, there is a need to effectively analyze logs across different compute domains, including but not limited to endpoint, network, cloud, email, single-sign-on (SSO), security data lake, or anything that can generate alerts and logs, to identify threats, vulnerabilities, and for remediation.

### BRIEF SUMMARY

The present disclosure is directed to Security Operations Center (SOCs) and other security management systems for utilizing a structured representation in order to allow an AI agent to adaptively and continuously learn over time (e.g., “learning-on-the-job”). According to one implementation, a method includes a step of receiving feedback from a human analyst related to results of a task performed by an Artificial Intelligence (AI) agent. The method can include a step of converting the feedback into a structured representation having nodes and edges. Also, the method further includes a step of updating a knowledge database associated with the AI agent using the structured representation. The method can include a step of utilizing the structured representation and/or knowledge database to improve performance of the AI agent with respect to subsequent tasks.

According to some embodiments, the structured representation may be a knowledge graph, wherein the nodes represent user identities, IP addresses, domain systems, and/or cybersecurity threat intelligence indicators, and wherein the edges represent relationships among the nodes including temporal, logical, and/or causal relationships. The structural knowledge could be also encoded as logic programs, which extend first-order logic (FOL) and are sets of logical statements—facts and rules—that describe knowledge about a domain, allowing computers to perform reasoning and inference. The AI agent, in some embodiments, may be configured to investigate one or more cybersecurity alerts to determine whether the one or more cybersecurity alerts are indicative of a real malicious threat or benign behavior. Also, the AI agent may originally be deployed with an initial pretrained model and may be configured for adaptive learning-on-the-job based on the structured representation.

In some implementations, the method may further include a step of adjusting behavior of the AI agent in future tasks based on updating the knowledge database using a sample-efficient learning process. Also, according to some embodiments, the feedback may be configured as personalized coaching for improving the performance of the AI agent. Furthermore, the method, in some cases, may further include a step of performing structured reasoning, symbolic reasoning, and/or knowledge graph reasoning by applying first-order or second-order logic inference to the knowledge database. The structured representation, for example, may include company-specific nodes and cross-company relational nodes in a multi-tenant configuration.

In some embodiments, the method may further include steps of a) dividing a task into subcomponents, and b) applying a divide-and-conquer strategy to investigate each subcomponent using knowledge in the structured representation. Additionally, the method may include a step of performing an initial training of the AI agent using a bootstrapping dataset comprising labeled examples of historical cybersecurity alert investigations. Furthermore, the method may also include steps of a) allowing the AI agent to investigate incoming security alerts by classifying each security alert as either benign or malicious based on contextual signals, and b) allowing the human analyst to provide feedback identifying whether a specific investigation outcome is correct or incorrect.

The method, in various implementations, may further include a step of applying a weighting scheme to conflicting signals in the knowledge database during a reasoning process, the weighting scheme prioritizing signals based on reliability and contextual relevance. Also, the method may include steps of a) investigating Security Operations Center (SOC) or Security Information and Event Management (SIEM) alerts, and b) determining whether a user location anomaly is due to a legitimate virtual private network (VPN) or a potential attacker, based on Endpoint Detection and Response (EDR) signals. The AI agent, in some embodiments, may use symbolic reasoning to simulate human decision-making processes using logic-based knowledge encoded in the structured representation. Also, the structured representation may include a symbol-based or tree-based arrangement of nodes and edges.

### BRIEF DESCRIPTION OF THE DRAWINGS

The present disclosure is illustrated and described herein with reference to the various drawings. Like reference numbers are used to denote like components/steps, as appropriate. Unless otherwise noted, components depicted in the drawings are not necessarily drawn to scale.

FIG. 1 is a block diagram illustrating a computing system of a Security Operations Center (SOC), according to various embodiments of the present disclosure.

FIG. 2 is a block diagram illustrating a security log management system, according to various embodiments.

FIGS. 3A-3C are diagrams illustrating an example of abductive reasoning.

FIGS. 4A-4C are diagrams illustrating abductive reasoning procedures for investigating suspicious behavior related to potential cyber security threats, according to various embodiments.

FIG. 5 is a diagram illustrating modules of a log comprehension system, according to various embodiments.

FIGS. 6A-6F are diagrams illustrating examples of security attack lifecycles of different attacks.

FIG. 7 is a flow diagram illustrating an example of a Security Orchestration, Automation, and Response (SOAR) playbook for managing cyber security threats.

FIG. 8 is a table comparing characteristics of the SOAR playbook described with respect to FIG. 7 with characteristics of embodiments of log investigation procedures described in the present disclosure.

FIG. 9 is a flow diagram illustrating a method for automatically investigating security alerts, according to various embodiments of the present disclosure.

FIG. 10 is a block diagram illustrating an AI agent, highlighting functional components, and illustrating use of intent-object pairs to define agent-specific capabilities, according to various embodiments.

FIG. 11 is an example of a screenshot of a user interface showing an SOC report 160 regarding an alert of a potential breach.

FIG. 12 is a diagram illustrating an example of a Knowledge Graph.

FIG. 13 is a diagram illustrating an adaptive system configured to enable an AI agent to be properly modified after initial deployment, according to various embodiments of the present disclosure.

FIG. 14 is a flow diagram illustrating a method for utilizing a structured representation in order to allow an AI agent to adaptively and continuously learn over time (e.g., “learning-on-the-job”), according to various embodiments of the present disclosure.

### DETAILED DESCRIPTION

The present disclosure relates to systems and methods for obtaining logs from compute domains, wherein the logs are related to the detection of potential security threats at various locations throughout the compute domains. More specifically, these logs are then analyzed or investigated, using both computing resources (e.g., computers, Machine Learning (ML) models, Large Language Models (LLMs), etc.) as well as human resources (e.g., security management teams, IT professionals, network operators, technicians, etc.).

A strategy or technique for handling security threats can be defined in a “security playbook” or “cyber security response playbook.” The security playbook outlines a plan of actions that can be taken in the event of a security incident. Playbooks are normally a key component of cybersecurity, IT incident management, DevOps, etc. Also, these playbook may include standard procedures and steps for responding to security incidents in real-time and may also include training instructions for presenting or demonstrating how new team members are expected to respond to future security threats. Also, it should be noted that playbooks may include procedures that are automatically or manually instantiated. According to the embodiments of the present disclosure, Machine Learning (ML) models and Large Language Models (LLMs) are used in a way that replaces many of the tedious manual tasks with automated procedures.

There has thus been outlined, rather broadly, the features of the present disclosure in order that the detailed description may be better understood, and in order that the present contribution to the art may be better appreciated. There are additional features of the various embodiments that will be described herein. It is to be understood that the present disclosure is not limited to the details of construction and to the arrangements of the components set forth in the following description or illustrated in the drawings. Rather, the embodiments of the present disclosure may be capable of other implementations and configurations and may be practiced or carried out in various ways. Also, it is to be understood that the phraseology and terminology employed are for the purpose of description and should not be regarded as limiting.

As such, those skilled in the art will appreciate that the inventive conception, upon which this disclosure is based, may readily be utilized as a basis for the designing of other structures, methods, and systems for carrying out the several purposes described in the present disclosure. Those skilled in the art will understand that the embodiments may include various equivalent constructions insofar as they do not depart from the spirit and scope of the present invention. Additional aspects and advantages of the present disclosure will be apparent from the following detailed description of exemplary embodiments which are illustrated in the accompanying drawings.

### Computing System of a Security Operations Center (SOC)

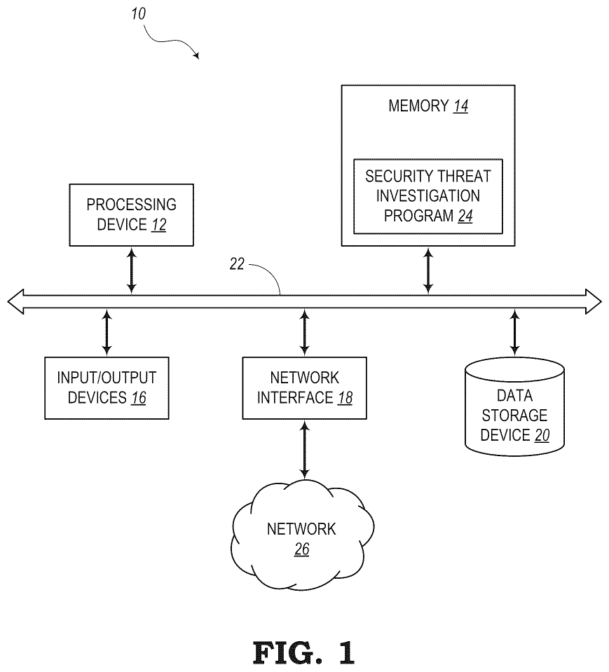

FIG. 1 is a block diagram illustrating an embodiment of a computer system 10 that may be used in a Security Operations Center (SOC) for investigating security threats in compute domains. For example, the SOC may be implemented via one or more servers in a cloud-based facility that is configured to assist one or more organizations with cyber security monitoring in a security-as-a-service role. In other embodiments, the SOC may be incorporated within the compute domains of a specific organization (e.g., business, enterprise, university, etc.) for monitoring security threats on-premises. In still other embodiments, the SOC may be arranged between an organization's domain and the Internet to provide security services to the organization in a firewall-type role. For example, the SOC may have inline service functionality and operate as a Secure Internet system or Web Gateway system.

As shown in FIG. 1, the computer system 10 may be a digital computing device that generally includes a processing device 12, memory 14, input/output (I/O) devices 16, a network interface 18, and a data storage device 20 base. It should be appreciated that FIG. 1 depicts the computer system 10 in a simplified manner, where some embodiments may include additional components and suitably configured processing logic to support known or conventional operating features. The components (i.e., 12, 14, 16, 18, 20) may be communicatively coupled via a local interface 22 or bus interface. The local interface 22 may include, for example, one or more buses or other wired or wireless connections.

The computer system 10 may be utilized in various embodiments of the present disclosure having one or more Central Processing Units (CPUs) and/or other processing devices, which may be implemented as one or more microprocessors, controllers, or other computational units capable of executing instructions. For example, the processing device 12 may operate in conjunction with memory components, such as memory 14, which may include volatile memory (e.g., Random Access Memory (RAM)) and non-volatile memory (e.g., Read-Only Memory (ROM), flash memory, or other persistent storage mediums). The memory 14 can store both program instructions and data necessary for the operation of the computer system 10 and execution of the functionality described in the present disclosure.

In addition to the processing device 12 and memory 14, the computer system is equipped with a variety of input/output (I/O) devices to facilitate interaction with users and other external systems. These I/O devices may include keyboards, pointing devices (e.g., mice, touchpads), displays (e.g., monitors, screens), printers, scanners, speakers, microphones, cameras, and other peripherals. The computer system further includes interfaces and drivers to enable communication and data exchange between the processing device and the various I/O devices.

Furthermore, the computer system 10 is equipped with a network interface 18 or network adapter that enables connectivity to one or more networks (e.g., network 26), such as local area networks (LANs), wide area networks (WANs), the Internet, or other communication networks. The network interface 18 may utilize wired or wireless communication protocols and hardware (e.g., Ethernet, Wi-Fi, Bluetooth, etc.) to facilitate data transmission and reception with other devices and systems.

The computer system 10 also incorporates a data storage device 20 (e.g., database, data store, database management system, database engine, etc.) for storing, organizing, and managing data relevant to the embodiments of the present disclosure. The data storage device 20 may utilize various data storage technologies and structures (e.g., relational databases, NoSQL databases, etc.) to efficiently store and retrieve data in accordance with the requirements of the present embodiments.

Additionally, the computer system 10 includes a local interface 22 (e.g., bus architecture, bus interface, etc.) that facilitates communication and data transfer between the processing device 12, memory 14, I/O devices 16, network interface 18, data storage device 20, and other system components. The local interface 22 may employ standard bus protocols (e.g., PCI, USB, etc.) to enable seamless integration and interoperability between various hardware components and peripherals within the computer system 10.

In operation, the processing device 12 may execute program instructions stored in memory 14, interact with input/output devices 16 for user interaction and data exchange, communicate over the network interface 18 for remote access and data transfer, access and manipulate data stored in the data storage device 20, and utilize the bus interface to coordinate communication and data transfer between different components of the computer system 10. These components collectively enable the computer system 10 to implement the functionality of the embodiments of the present disclosure and perform the tasks described herein.

In particular, the computer system 10 may include a security threat investigation program 24, which may be implemented in any suitable form of hardware (e.g., in the processing device 12) and/or software or firmware (e.g., in the memory 14). The security threat investigation program 24 may be configured to obtain logs of potential security issues or vulnerabilities from various sources in compute domains. Also, the security threat investigation program 24 is configured to process these logs to generate a security plan (e.g., playbook), which can be generated, edited, etc. with the help of an LLM and/or one or more security team members. Next, the security threat investigation program 24 may be configured to perform a log comprehension procedure, which may be executed primarily by an LLM or other ML-based models. The security threat investigation program 24 may also engage the help from one or more users to clarify various issues as needed. Then, the security threat investigation program 24 may be configured to execute the security plan, which may also involve an LLM, and then report the results to a security team, network operator, etc.

While FIG. 1 illustrates a single computer system 10, those skilled in the art will recognize the SOC contemplates implementation in various different approaches. Generally, in all approaches, there will be one or more physical computer systems 10 ultimately executing the SOC and the security threat investigation program 24. In some embodiments, the security threat investigation program 24 can be implemented in Virtual Machines (VMs), software containers, software dockers, and the like. In some embodiments, the security threat investigation program 24 and the SOC may be realized as a cloud service, such as in a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser, application, or the like, with no installed client version of an application required. Centralization gives cloud service providers complete control over the versions of the browser-based and other applications provided to clients, which removes the need for version upgrades or license management on individual client computing devices. The phrase “Software as a Service” (SaaS) is sometimes used to describe application programs offered through cloud computing. A common shorthand for a provided cloud computing service (or even an aggregation of all existing cloud services) is “the cloud.”

### Security Log Management System

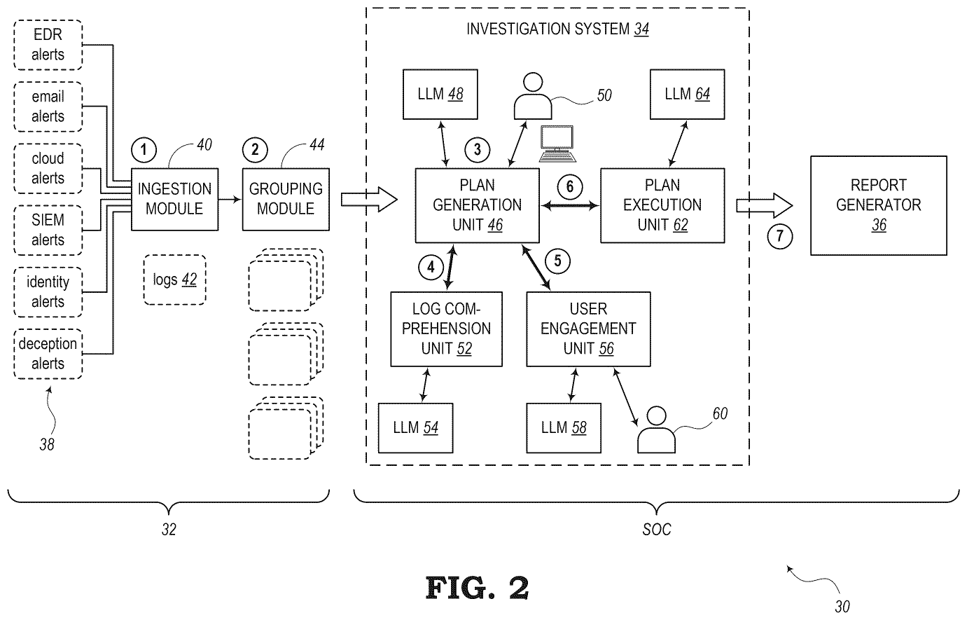

FIG. 2 is a block diagram illustrating an embodiment of a security log management system 30. As shown in FIG. 2, the security log management system 30 generally includes a compute domain 32 being monitored and the SOC (or computer system 10) shown in FIG. 1. The SOC, in this embodiment, includes an investigation system 34 and a report generator 36. The investigation system 34, for example, is configured to investigate logs obtained from the compute domain 32 to process potential security threats in the compute domain 32. The report generator 36 is configured to report results of the log investigation procedures for providing information about discovered security issues, context of the security issues, possible mitigation solutions, charts, tables, graphs, summarizations, etc.

The compute domain 32 may include self-monitoring devices, telemetry components, etc. for detecting potential security issues or alerts 38. The alerts 38 may be detected at various locations within the compute domains by any suitable number of sources. For example, the alerts 38 may include EDR alerts, email alerts, cloud alerts, SIEM alerts, identity alerts, deception alerts, among others. The alerts 38 are fed to an ingestion module 40, which is configured, in a first stage, for creating logs 42 in a predetermined format. For example, the logs 42 may be recorded with specific information, such as event time, event name, identity of security detection component, identity of network component (e.g., IP address), corresponding user agent, etc. In a second stage, a grouping module 44 may be configured to obtain the logs 42 and group them according to specific categories (e.g., types of security alerts, types of network components associated with the alerts, malicious alerts, benign alerts, etc.). At this point, the logs (or groups of logs) are provided to the SOC for processing the logs.

In the third stage, an alert comprehension component is used to understand and analyze the alerts. This component involves the assistance of another LLM for automatically comprehending the security threat alert. The component aims to answer the following questions. (1) What entities triggered the alert, such as process, IP address, file, API usage, etc.; (2) When the alert is triggered; (3) Where the alert is triggered, such as the device name, AWS IAM, user name, etc.

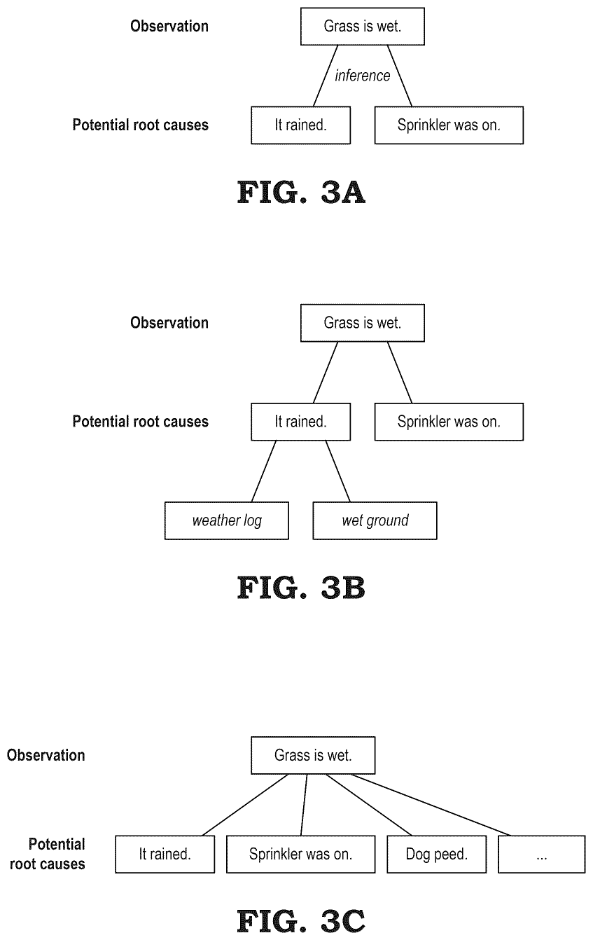

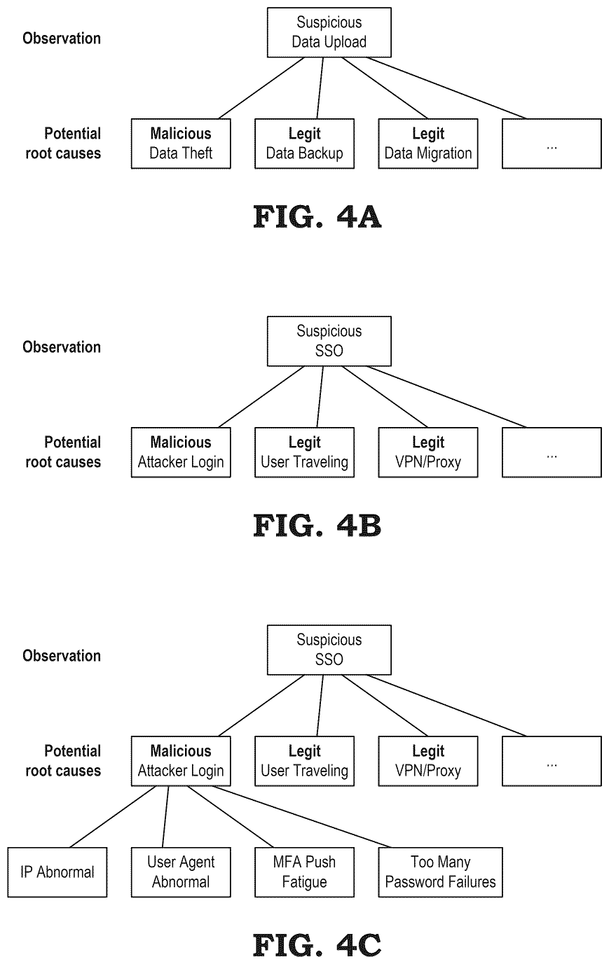

As shown in FIG. 2, the investigation system 34 of the SOC includes a plan generation unit 46, which is configured to receive the logs from the compute domain 32. In a third stage, the plan generation unit 46 is configured to involve the assistance of a neural-symbolic AI model involving a first LLM 48 for automatically creating a plan (e.g., playbook) for investigating the logs. Also, the plan generation unit 46 may involve the assistance of one or more security team members 50 for resolving planning issues that may be germane to the specific compute domain 32 and/or that require human intervention. In some embodiments, various plan generation steps may include logical reasoning, such as abductive reasoning, described in FIGS. 3 and 4, and may be performed automatically by the LLM 48.

Next, in a fifth stage, the investigation system 34 further includes a user engagement unit 56, which may be assisted by another LLM agent 58 and/or a specific user 60, who may be recognized as having a particular presence as an end user (or someone affiliated with a certain end user) in the compute domain 32. The user engagement unit 56 may therefore be configured to provide help with the plan generation procedure to obtain explanations, verifications, or other types of feedback regarding unusual logs, which may be the result of an employee changing offices, working remotely, utilizing a public Wi-Fi hotspot, uploading new software, employing a new computer, etc. In some cases, the user engagement may include asking a simple question to a supervisor of an employee, such as, “Is Hudson still working from the remote office in Spain?”

After comprehending alerts, the generation of a security plan, and user engagement, the investigation system 34 further includes a plan execution unit 62, which is configured to automatically execute the plan or playbook according to a sixth stage. The plan execution unit 62 may also employ the assistance of an LLM 64. In each execution step, the LLM needs to pull logs, and enrichment data from various sources, including SIEM, Company internal Wiki, code based, Calendar, etc., as well as the knowledge graph maintained by Culminate. The agent performs reasoning over the collected data and the knowledge graph information. Based on the intermediate execution and reasoning results, the plans are dynamically updated by ML models, including LLM and traditional models. For example, based on the execution results until step [x], some later steps in the original plan might be skipped, and a few additional steps might be added. Once the plan is executed and the logs are analyzed with respect to whether or not they truly are representative of a real security threat, the results can be communicated to the report generator 36 (i.e., stage seven), which can provide a report in any suitable form to the security team, executives, administrators, network operators, technicians, etc., as needed, to decide how the security issues should be handled at this point. In some cases, the organization may wish to perform automated remediation or mitigation steps to resolve the security issues. In other cases, the organization may wish to perform manual steps to resolve the issues.

In a sense, it may be noted that IT operations (IT Ops) can be moved to the cloud. Thus, the security (IT) team may be configured to utilize the computer system 10 of the SOC to monitor security threats in the compute domain 32 of an organization. Generally, cloud logs are complex and require expertise in IT or security to review and determine problems, anomalies, etc. One focus in the embodiments of the present disclosure, therefore, is to utilize ML-based procedures, such as LLMs, which can be exceptionally effective at performing the tedious tasks of sifting through large volumes of logs.

The SOC, in the field of cybersecurity, can use various products, which may be categorized as a) Managed Detection and Response (MDR) modules, b) Extended Detection and Response (XDR) modules, c) Endpoint Detection and Response (EDR) modules, d) Network Detection and Response (NDR) modules, etc. Some examples of cloud logs may include logs obtained from various platforms (e.g., Amazon Web Services (AWS), Microsoft Azure, Google Cloud Platform (GCP), etc.).

### Abductive Reasoning

FIGS. 3A-3C are diagrams illustrating a textbook example for defining the concept of abductive reasoning, which may also be referred to as abduction, abductive inference, etc. Essentially, abductive reasoning is a form of logical reasoning or logical inference that seeks the simplest and “most likely” conclusion from a set of observations. In this example, the abduction reasoning includes an observation that the “grass is wet.” Using inference, it is possible to find the most likely, but not necessarily the most comprehensive, potential root causes of the grass being wet. In the example of FIG. 3A, two potential root causes can be explained as either “it rained” or the “sprinkler was on.”

As described in more detail below, the plan generation unit 46 shown in FIG. 2 may use abductive reasoning to automatically and/or manually infer potential root causes of certain logs. Nevertheless, returning to the textbook example, FIG. 3B includes investigation steps related to the potential root cause of “it rained” and look at the weather log to determine if there really was a measurement amount of rainfall in the area and checking the ground in the surrounding areas to see if they really are wet. Suppose, for example, that there was no measured rainfall, the ground in the surrounding areas was not wet, and it was determined that the sprinkler was not turned on. In this case, more investigation is needed to find the real root cause. As suggested in FIG. 3C, suppose that a video recording of the grass in question is checked and it is found that a dog and its owner stopped for a minute to allow the dog to pee. Of course, there may be any number of additional possible (although less likely) root causes of the grass being wet, such as a bunch of kids having a water balloon fight, a person watering plants and leaving a hose on, a street sweeper gone wild, etc.

FIGS. 4A-4C are diagrams illustrating abductive reasoning procedures for investigating suspicious behavior related to potential cyber security threats. As shown in FIG. 4A, reviewing the security logs may result in an observation that there is a “suspicious data upload” in the compute domain. From this observation, several likely root causes may be inferred. In one case, a potential root cause may represent malicious activity where data theft is involved. In other cases, the potent root causes may represent benign or legit activities, such as a data backup operation or a data migration operation.

In FIG. 4B, the logs may reveal another observation that there was a suspicious Single Sign-On (SSO) action. From this observation, several potential root causes may be inferred. For example, the suspicious SSO action may be the result of a malicious attacker login, a legit user traveling and logging in using unrecognized equipment, a legit VPN or proxy login action.

In FIG. 4C, the malicious attacker login shown in FIG. 4B is further investigated. In this case, some details may be observed about the login, such as an IP address was abnormal, a user agent was abnormal, a Multi-Factor Authentication (MFA) push fatigue attack, or too many password failure attempts.

### Log Comprehension

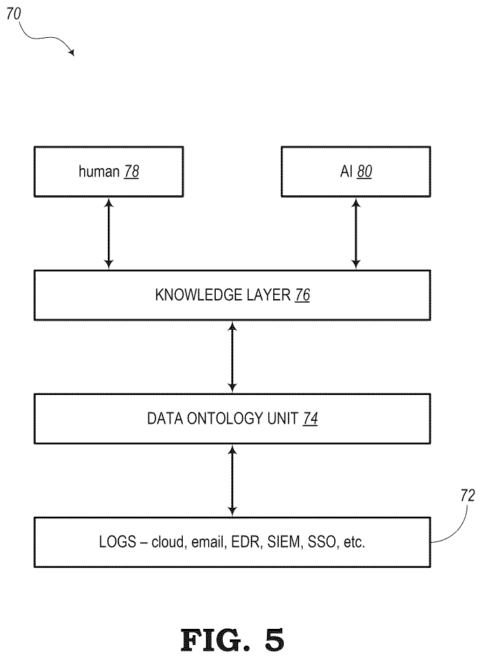

FIG. 5 is a diagram illustrating an embodiment of a log comprehension system 70, which may include components or modules of the log comprehension unit 52 shown in FIG. 2. As illustrated, the log comprehension system 70 obtains logs 72 (e.g., logs 42) from various sources in a compute domain. The logs 72 may include cloud logs, email logs, EDR logs SIEM logs, SSO logs, among others.

The log comprehension system 70 further includes a data ontology unit 74. For instance, the data ontology unit 74 may be configured to link data regarding the various logs 72 in any suitable manner, which may be based on certain classification concepts. The data ontology unit 74 may link, group, and/or organize similar security threat events together using ML models (e.g., LLM 54). In some embodiments, the data ontology unit 74 may use a relational database associated with the LLM 54 to find links. The data ontology unit 74 may represent knowledge of specific details in the logs 72 to define various aspects of the logs 72, such as type, classification, parameters, relationships, constraints, etc. in a structured and organized fashion, to thereby provide a systematic framework for understanding and categorizing the logs 72 and their interconnections.

Furthermore, the log comprehension system 70 includes a knowledge layer 76, which may include the data, metadata, and linking (relational) information of the logs determined by the data ontology unit 74. The knowledge layer 76 may be viewed and/or modified by a human 78 and/or AI 80 based on various knowledge, understandings, deductions, etc. of the logs, the associated compute domain, end users, etc.

### Security Attack Examples

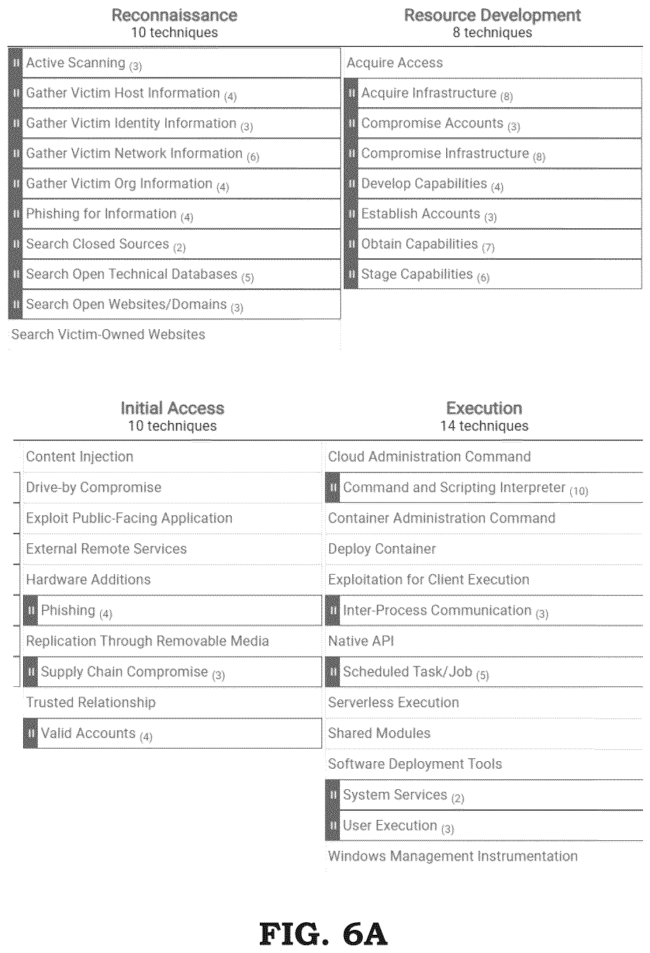

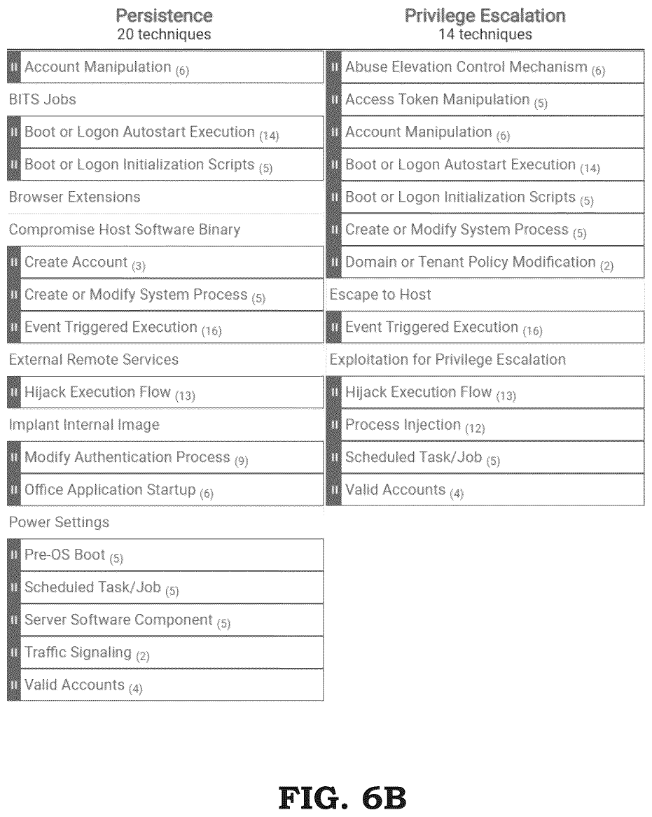

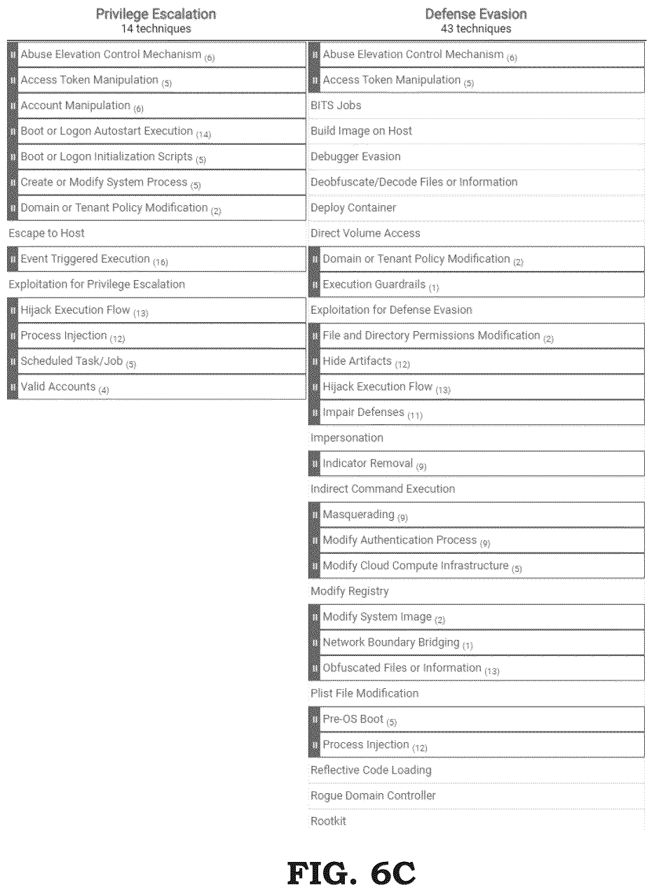

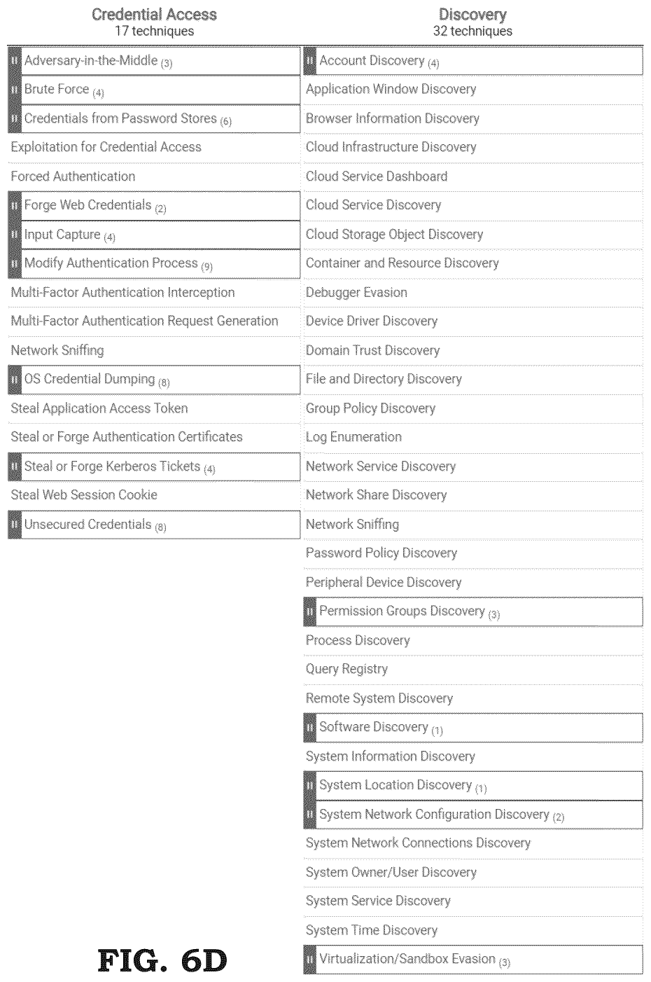

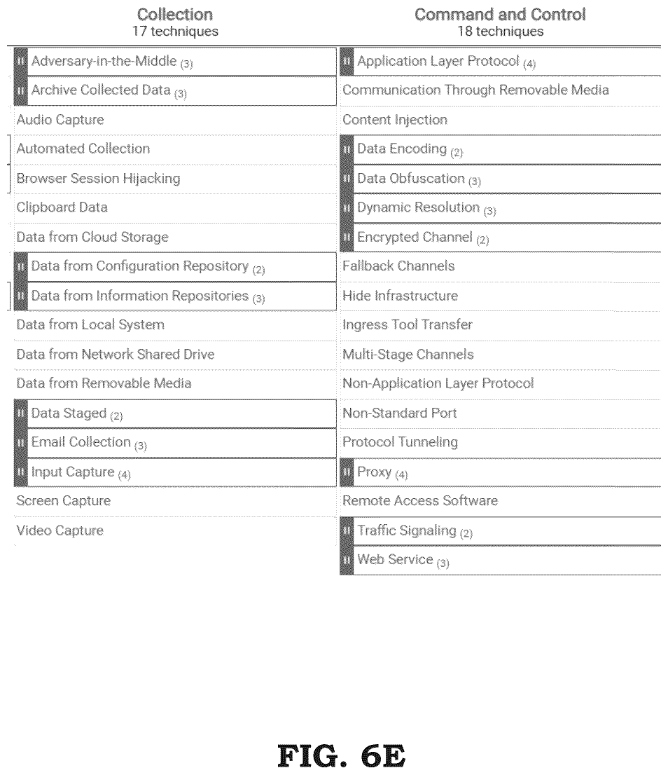

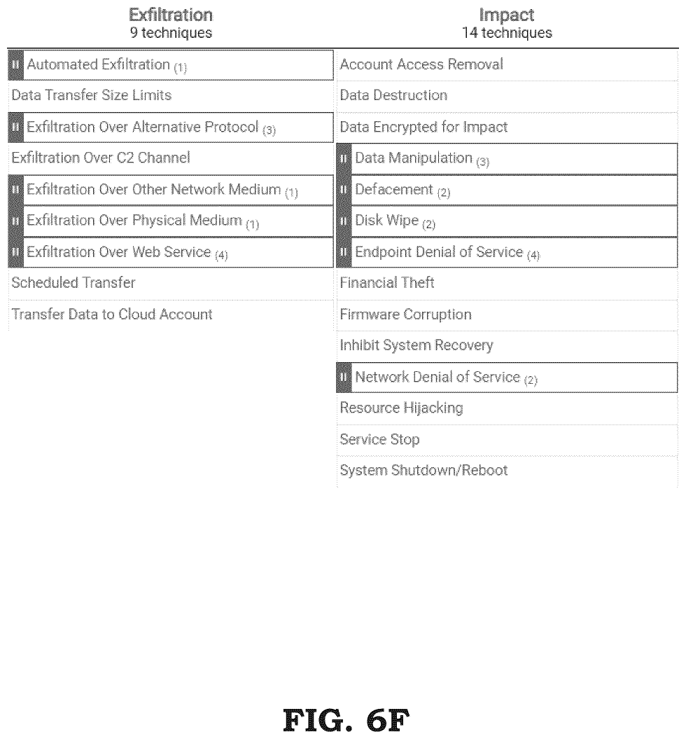

FIGS. 6A-6F are a diagram illustrating examples of security attack lifecycles of different attacks, such as the MITRE ATT&CK framework. A lifecycle of attacker actions is shown, wherein the attack lifecycle in this example includes steps of initial access, recon, privilege escalation, established persistence/maintain presence, defense evasion, and finally complete mission. Each of these steps includes a number of sub-steps. In the MITRE ATT&CK framework, wherein the attack lifecycle in this example includes steps of reconnaissance, resource development, initial access, execution, persistence, privilege escalation, defense evasion, credential access, discovery, lateral movement, collection, command and control, exfiltration, and impact. Again, each of these steps can include a number of sub-steps. The embodiments of the present disclosure are configured to utilize knowledge of each of the steps and sub-steps in these and other types of attacks for automatically analyzing and comprehending log information that may seem to represent an actual security attack or at least bring up an alert that can be further investigated (automatically or manually).

Differences from Security Orchestration, Automation, and Response (SOAR)

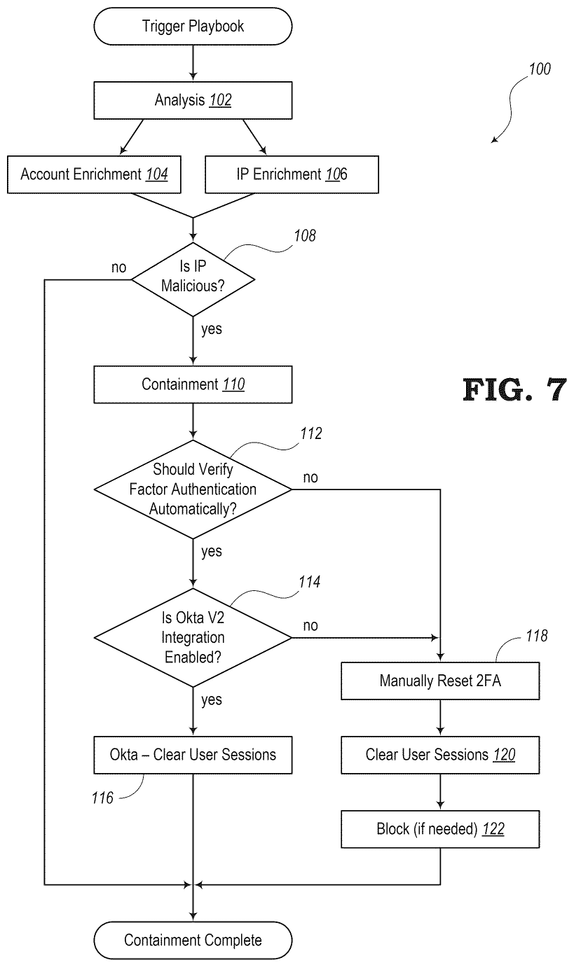

FIG. 7 is a flow diagram illustrating an example of a Security Orchestration, Automation, and Response (SOAR) playbook 100 for managing cyber security threats. Such fixed playbook was the last generation of solution to automate the alert investigation and response. As shown, when the SOAR playbook 100 is triggered, an analysis step 102 is performed. The SOAR playbook 100 may include account enrichment 104 and/or IP enrichment 106 steps. Next, the SOAR playbook 100 is configured to determine if the IP is malicious, as indicated in condition block 108. If not, the process ends. Otherwise, if IP is found to be malicious, the SOAR playbook 100 goes to block 110, which includes a containment step.

Next, the SOAR playbook 100 includes determining whether a verify factor should be authenticated automatically, as indicated in condition block 112. If not, the SOAR playbook 100 goes to block 118. Otherwise, if the verify factor is to be authenticated automatically, a condition block 114 determines if Okta V2 Integration is enabled. If not, the SOAR playbook 100 proceeds to block 118. Otherwise, Okta clears the user sessions, and the containment is completed. In block 118, the SOAR playbook 100 includes a step of manually resetting 2FA. Also, as indicated in block 120, the SOAR playbook 100 includes a step of clearing the user sessions. Also, the SOAR playbook 100 may include a blocking step (if needed), as indicated in block 122. Then, the SOAR playbook 100 completes containment and ends.

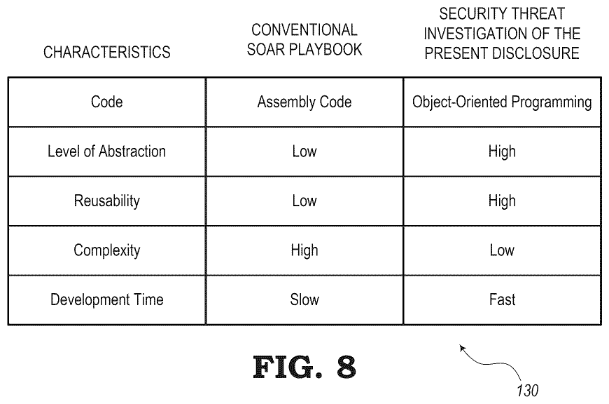

FIG. 8 is a table 130 comparing characteristics of the SOAR playbook described with respect to FIG. 7 with characteristics of embodiments of log investigation procedures (e.g., security threat investigation program 24, investigation system 34, etc.) described in the present disclosure. Compared to conventional SOAR playbooks, the systems and methods of the present disclosure generalize better to unseen threats, as they have a higher level of abstraction, a higher level of reusability, lower complexity, and a faster development time. The conventional SOAR requires a high skill set to create investigation playbooks. While the new method can automatically generate and execute the investigation playbook based on a few simple human natural language sentences. The difference between traditional SOAR playbooks and the one in the present disclosure is similar to the difference between assembly code vs object-oriented programming languages.

### Automated Security Alert Investigation Process

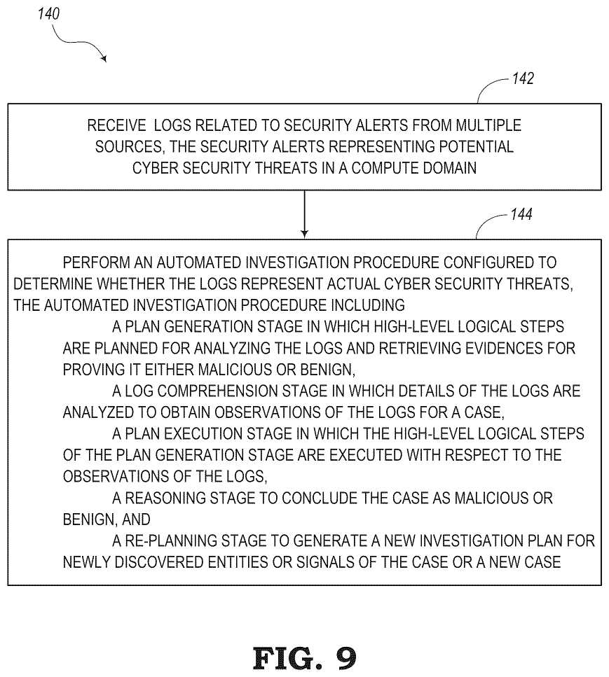

FIG. 9 is a flow diagram illustrating an embodiment of a method 140 for automatically investigating security alerts. As shown in FIG. 9, the method 140 includes a step of receiving logs related to security alerts from multiple sources, the security alerts representing potential cyber security threats in a compute domain, as indicated in block 142. The method 140 further includes a step of performing an automated investigation procedure configured to determine whether the logs represent actual cyber security threats, as indicated in block 144. For example, the automated investigation procedure includes (a) a plan generation stage in which high-level logical steps are planned for analyzing the logs and retrieving evidences for proving it either malicious or benign, (b) a log comprehension stage in which details of the logs are analyzed to obtain observations of the logs for a case, (c) a plan execution stage in which the high-level logical steps of the plan generation stage are executed with respect to the observations of the logs, (d) a reasoning stage to conclude the case as malicious or benign, and (e) a re-planning stage to generate a new investigation plan for newly discovered entities or signals of the case or a new case.

According to some embodiments, the plan generation stage is configured to receive planning assistance from a neural-symbolic AI model including a Large Language Model (LLM). The plan generation stage can further be configured to receive planning assistance from a security expert knowledge, wherein the security expert knowledge is provided by a security team or auto-acquired by (1) learning from humans' past investigation stored in case management system, e.g., Jira tickets, (2) learning from past live feedback such as via feedback from human security analysts on past investigation results, or (3) learning from provided textbooks, such as from training bootcamps such as the SANS Institute, Blackhat conferences, etc. The security expert knowledge is (1) encoded as plain texts and used via Retrieval Augmented Generation (RAG) in the LLM or (2) encoded as a knowledge graph and leveraged by the neural-symbolic AI model.

The log comprehension stage, in some implementations, may involve logic-based abductive reasoning, wherein the logic-based abductive reasoning includes deductive reasoning and inductive reasoning for inferring potential root causes of suspicious activities observed in the security alerts. The log comprehension stage may also include comprehension assistance from an LLM trained specifically for the compute domain. The log comprehension stage may also include a step of performing an unsupervised learning procedure on the logs to obtain a knowledge layer. First, it trains an unsupervised learning model that clusters the past sessions of user activities, followed by a cluster assignment for the session under investigation. If a similar cluster is found for the session under investigation, then the tags on the cluster provide human readable description of the user activity. The tags can either be provided by humans or automatically derived by LLM. When generated by LLM, the tags present the patterns and knowledge that are prevalent across the majority of the cases in the cluster. The tags are the knowledge provided by security experts.

The plan execution stage can include executing a variety of different actions. The different actions can include (1) a step of presenting auto-generated predefined questions to one or more end users regarding the potential cyber security threats, (2) a step of auto translating a natural language question to database queries or Application Programming Interface (API) calls, or (3) a step of retrieving answers to investigation questions specified in the plan generation stage using institutional knowledge specific to each company, where the institutional knowledge is via Retrieval Augmented Generation (RAG) in an LLM.

In some embodiments, the plan execution stage may include a step of presenting predefined questions to one or more end users regarding the potential cyber security threats. The automated investigation procedure, in some implementations, may further include a report generation stage in which results of executing the logical steps of the plan generation stage are provided to a security team. For instance, the logs are obtained using Machine Learning (ML) models and LLM agents by measuring or testing email systems, cloud systems, Security Information and Event Management (SIEM) systems, Endpoint security tools such as Endpoint Detection and Response (EDR) systems, Antivirus systems, device management systems, Network security tools such as Network Detection and Response (NDR) systems, firewalls, proxies, virtual private network, web applications, secure service access edge (SASE), code development systems such as source code management, continuous integration, and continuous deployment Managed Detection and Response (MDR) systems, Extended Detection and Response (XDR) systems, identity detection systems, and deception detection systems, of the compute domain.

### Additional Examples

According to various embodiments of the present disclosure, the systems and methods are configured to provide Autonomous Security Operations. The systems and methods are configured to perform investigation procedures, which may have three main functional components:
1) Log comprehension—via a generative AI model combining LLM model,
2) Plan generation—via a neural-symbolic architecture involving probabilistic abductive reasoning over knowledge graph
3) Plan execution, user interaction and report generation—via LLM

In a first Use Case, suppose, for example, that a security investigation is being carried out for a company in the technology sector having about 1,000 employees and one cloud security engineer. Also, suppose, in this case, that an alert arises where it is observed that an employee who was terminated a few months ago still has activities on AWS. The investigation may include automatically reading logs obtained before and after the termination to understand what may have happened. Of course, over the span of several days, there may be thousands of lines or logs of various events. Each line (or log) may include event times, event names, source IP addresses, user devices, etc. In this example, the log comprehension system 70 of FIG. 5 may be used to sift through the multiple lines of data using AI-based techniques (e.g., LLM 54) to determine if the data tends to point to inappropriate behavior on the part of the terminated employee or if there are other explanation for the security event issues, such as the terminated employee contacting the company to retrieve personal information, another employee using old equipment previously used by the terminated ex-employee, etc. Many false alarms can be automatically eliminated by training and utilizing the LLM 54.

In a second Use Case, suppose, for example, that a security investigation is being carried out for a company in the technology sector having over 1,000 employees and ten security analysts. Also, suppose, in this case, that an alert arises where it is observed that an “iam entity” S3 API exhibits anomalous behavior with respect to a “putObject” command. It may be observed from the past that the user typically uses “getObject,” but now he is using “putObject.” An investigation may be performed in the scenario to prove whether the alert is malicious or benign, whether a user is guilty or innocent, or other results. The investigation may include the use of Abductive Reasoning to provide a best explanation for the observations. Again, the abductive reasoning may include both deductive reasoning and inductive reasoning.

The systems and methods of the present disclosure may be incorporated in, performed by, and associated with the computer system 10, security threat investigation program 24, SOC, investigation system 34, method 140, etc. The present disclosure may also include additional features for investigating possible security issues. In one example, the present disclosure may include a way to prioritize or triage logs. In other words, certain security alerts may be considered to be more critical and should be handled before others. Therefore, the plan generation unit 46 may be configured to receive the grouped logs from the grouping module 44 and perform an initial prioritization (or triage) process to identify and order the logs according to importance, which may be based on various factors and can be predefined.

It may also be noted that the alerts 38 obtained in the compute domain 32 may be detected using ML models. Thus, the ML models in this case may be set with a high sensitivity to consider all possible situations that could be indicative of a real security event. Thus, with additional information, the investigation system 34 may be configured to sort through a larger set of log events to investigate if the logs are related to real issues. Since this may be difficult for a human operator, LLMs and other ML models may be used to assist with the investigations to determine if the logs are malicious or benign.

In some situations, an MDR system may be used by a company that could not normally afford to support their own security team. They might outsource this SOC service to managed devices and services to help them to manage their security. With the SOC systems and methods of the present disclosure, the company may change their business model to include fewer security employees to allow the humans to focus on aspects that are more critical, high-level, or require human decision making, as opposed to tedious reading through hundreds or thousands of logs.

Again, a security analyst may be labeled as Level One (L1) or Level Two (L2), where an L1 analyst may have limited experience or knowledge. These security analysts are often put in charge of performing the tedious tasks. Once they become more proficient, they may be promoted to L2 and help train new L1s as they are onboarded. Thus, in conventional systems, an L1 analyst may perform manual correlations using certain tools and traditional manually written playbooks, but this is quite clumsy and can lead to many mistakes. Thus, a differentiator in the present disclosure is that the investigation procedure, from end to end, can be performed with assistance (at each step) from ML models, LLMs, etc. One of these steps may include actually journalling the playbook automatically with help from an LLM.

Also, in some respects, the investigation system 34 acts as an orchestrator, taking a number of various security analysis tools and putting them together. For instance, as MDR is to put data together, the investigation system 34 of the present disclosure can operate on top of this layer to leverage that data. Furthermore, the investigation system 34 can start with cloud-based logs first and may target cloud data from AWS GuardDuty alerts (e.g., intelligent threat detection), Microsoft Azure alerts, Microsoft Copilot alerts, GCP alerts, etc.

With respect to conventional systems, in order to get answers to certain log questions, it was essentially necessary to hold the hand of a chatbot in order to enter a question. However, with the systems and methods of the present disclosure, the LLM is able to comprehend the logs to find legitimate alerts. Then, a human operator can easily review a smaller sample of alerts to determine how to respond to real security issues. In some respects, the systems and methods of the present disclosure are performing the task of the L1 analyst to uncover potential security threats. Then, this short list can be analyzed with an L2 analyst to determine remediation steps.

Regarding one example, suppose there are a pair of events repeated multiple times in the logs. For example, suppose the events are identified as a “Console Login” and a “Get Sign-in Token.” Also, suppose that the automated investigation determines that over time, these two events occur on different days. It may also be investigated that the IP addresses (in these logs) change, but for the Console Login instances, it was always the same IP. The investigation steps of the present disclosure may conclude that from these triggers, it may be determined that the Get Sign-in Token may actually represent a backend (e.g., AWS). In this case, this situation may mean that the log for the cloud is actually even harder to understand.

The logs, from some perspectives, may be considered to be like a text version of a video recording, having a great amount of information for a relatively small amount of content. It may be difficult to understand how a person might go about analyzing such detailed information. However, in the case of AWS, Azure, GCP, and the like, the backend environment may be more compact. When something happens in the backend, there are multiple things triggered in the logs and may be viewable in the frontend. Even a small simple trigger in the backend can be difficult for analysis by human beings to look through, read, and understand what is actually happening. This is where the ML components (e.g., LLM 48, LLM 54, LLM 58, LLM 64) come into play. In particular, the LLM 54 specifically may be involved in log comprehension to understand what the logs are actually describing and why they are triggered. The LLM 54 (and other LLMs) may be configured to understand the important aspects of the logs and filter out the noise. The systems and methods of the present disclosure may change how potential security threats are investigated. In some respects, the ML techniques may handle the dirty work, leaving humans with higher-level analysis and focusing on asking certain users about various unforeseen root causes that cannot be captured by machines, such as various login behaviors (regarding the above login example).

Another aspect of the present disclosure that is believed to be novel with respect to conventional systems is that a log (or group of logs) can be treated as if it is a word. The investigation system 34 is configured to take this log (or group of logs) as a word and combine it with other related logs (or groups) as if there were a sentence or paragraph. Then, with analysis and removal of irrelevant data, the LLMs and security teams can better understand this paragraph.

Some technical differentiations with respect to conventional systems show that the present disclosure is configured for auto-investigation based on logic-based reasoning. This may include Symbolic, Relational, and Hierarchical Planning. Also, the auto-investigation provides better reliability than AI agents that cannot perform well after more than about ten steps. The systems and methods described herein are configured to use ML models (e.g., LLM, anomaly detection, etc.) at the leaf node. The present disclosure is also provides correlation across different data sources (e.g., SSO, EDR, NDR, etc.). This may be similar to XDR. Another difference is that the present disclosure is configured to extract more signals than just correlating the existing signal. Also, the present systems can use identity tracking to nail down the same users.

Further distinctions show that the present disclosure is configured to find evidence via “log comprehension.” This may include reducing false positives (false alarm) by understanding the past behavior of various users. Also, the present disclosure can explain false positives with evidence, thereby describing what actually happened instead of simply lacking the evidence about true positives (e.g., an actual cyber security attack). Furthermore, the present disclosure may be configured to learn customers' institutional knowledge from one single example, in some cases. The present disclosure may also include embodiments with in-house (on-prem) fine-tuned LLM. This allows the systems and methods to auto-generate investigation reports and interact with users to get feedback.

One benefit or purpose of log comprehension, as described herein, is to decide whether a log is indicative of a malicious or benign event. With this technique, the present embodiments are able to reduce a lot of false alarms because they can recognize, for example, when certain sessions or behavior sequences are similar to a sequence that the user has been using all along. From this, the systems can determine that the behavior is legit. Then, for an even better training process, the systems and methods of the present disclosure can figure out what a session is trying to do, whether it is something that is generally done.

Again, the LLMs described herein may be trained on in-house data to better suit the actions and behaviors of the compute domains being monitored or investigated. From the logs, the LLMs can, to some degree, perform a summarization of activities, behaviors, patterns, end user actions, etc. They can summarize how many events there are and even understand the correlations of the events. They may determine which particular event happened first to determine root causes. They can investigate a statistical event and then give a summary of what the user most likely was trying to do. Many times, the LLM may initially infer that such events are actual security attacks. Thus, additional analysis by more LLMs and more human involvement can fine-tune the analysis.

As long as there is a key event that looks suspicious, the LLMs will think that the whole session is an attack. This is another differentiator from existing technology and one reason why in-house training of the LLM can be beneficial. Another aspect of differentiation from conventional systems is that the investigation system 34 is configured to automatically generate a security playbook, which means that when it comes to alerts, the investigation can start with an initial template instead requiring a new security team to start from nothing. The automatically constructed playbook can identify phishing alerts, email alerts, etc. and can automatically check various aspects of the compute domains, which may differ from one customer to another.

One way that a playbook or security investigating plan may be generated is defined in “Bias reformulation for one-shot function induction,” by Dianhuan Lin, Eyal Dechter, Kevin Ellis, Joshua Tenenbaum, and Stephen Muggleton, Frontiers in Artificial Intelligence and Applications, 2014, 525-530, IOS Press, the contents of which are incorporated by reference herein. This includes a high-level hierarchical planning strategy.

Regarding auto investigation, this may be referred to as an autopilot in a logical form. It is also relational, meaning that when one user is investigated, the embodiments of the present disclosure are able to pivot to another user based on how they are related. Not only is it automated, but also it is powerful. It can jump from one user to another user, then jump to another object. Then, that object may allow the present system to pivot to another user, etc., in a systematic way. This may be viewed as a spider web type of investigation or a kind of subtle investigation.

Additionally, in some embodiments, EDR systems of the present disclosure may perform hierarchical planning in the investigation. Basically, the attack stage may be breaking down into two different parts. With respect to the MITRE ATT&CK described herein, there are different attack stages. The EDR systems may use LLMs as described herein to divide and conquer for uncovering the attack. When the investigation of the present disclosure is performed, the systems and methods try to find a signal for each stage of the attack. Each stage itself can be broken down into different types of signals based on what data exists. A hierarchical goal involves a way to drive the investigation to realize it should look for (and get) this signal. In this sense, the methods are easy to execute and also reusable. The generated plan includes how the systems are able to do this hierarchical planning. Basically, the LLMs may have the building blocks to give it flexibility, as opposed to rigid human written playbook. The investigation system 34 is able to plan a different type of playbook, specially focused on the compute domain 32 being monitored. It can also automatically assemble a new playbook based on particular scenarios. In some respects, the LLM (e.g., GPT, chatbot, NLP system, etc.) may generate a playbook using human input and prompt engineering strategies.

### AI Agent

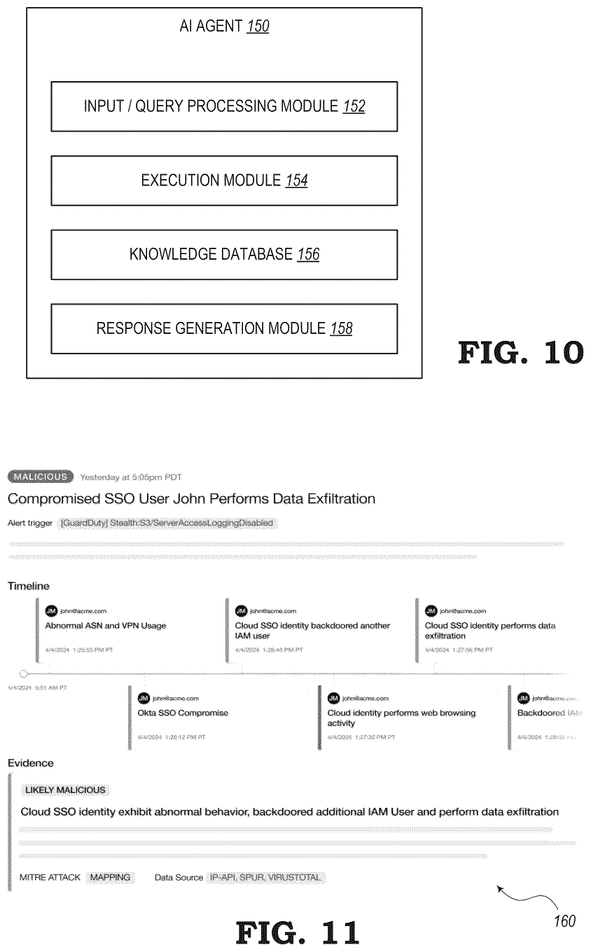

FIG. 10 is a block diagram illustrating an embodiment of an AI agent 150, highlighting functional components and illustrating use of intent-object pairs to define agent-specific capabilities. The AI agent 150 may be configured as a software entity executable by a computing system and may be designed to autonomously perform specific tasks or services through AI techniques. The AI agent 150 utilizes advanced Machine Learning (ML) models, Natural Language Processing (NLP), and automated decision-making capabilities to understand user inputs, determine appropriate actions, and execute specific tasks or actions without continuous human oversight.

The AI agent 150 may be configured to possess varying capabilities depending on its intended functions and the specific domain expertise it encapsulates. Capabilities of the AI agent 150 may encompass processing user requests, interpreting natural language queries, accessing specialized knowledge repositories, executing complex tasks, generating accurate responses tailored to user needs, and the like.

The AI agent 150 includes several interconnected functional components, including an input/query processing module 152, an execution module 154, a knowledge database 156, and a response generation module 158. These elements 152, 154, 156, 158 collectively enable the AI agent 150 to process user queries, execute tasks based on its unique capabilities, and generate appropriate responses. While illustrated as separate functional components, the functionality of the various elements 152, 154, 156, 158, as will be appreciated by those who are skilled in the art, may be combined in any suitable manner and/or may be further broken down according to various implementations.

The input/query processing module 152 is configured to receive and interpret incoming user queries, instructions, or requests. Typically, the input/query processing module 152 employs NLP techniques to parse and structure user-provided inputs, converting them into a format suitable for further processing within the AI agent 150. Following interpretation by the input/query processing module 152, structured queries are delivered to the execution module 154. The execution module 154 executes or performs tasks requested by the user. It may invoke various computational methods, algorithms, or procedures relevant to its operational domain, including AI models or Large Language Models (LLMs). The execution module 154 interacts with the knowledge database 156 to access data or information required for accurate task execution.

The knowledge database 156 stores domain-specific information, knowledge bases, data structures, or resources relevant to the tasks the AI agent 150 is designed to execute. It may serve as an internal source of truth, enabling the execution module 154 to quickly retrieve accurate information needed to perform requested actions or operations effectively. Once tasks are executed and relevant information is retrieved, the results are processed by the response generation module 158. The response generation module 158 formats and synthesizes outputs into clear, structured responses or instructions suitable for communicating back to the originating user or system. The generated responses can be delivered in various formats, including textual, audio, or visual information, depending upon the intended application and the nature of the user's initial request. Additionally, the responses may conform to standardized communication protocols such as the Model Context Protocol (MCP), Agent-to-Agent (A2A) protocol, or other suitable protocols, facilitating seamless and standardized interoperability between agents or between agents and users.

This simplified, modular architecture of the AI agent 150 demonstrates how an AI agent may process user requests, access knowledge, execute relevant tasks, and generate responses autonomously. It should be understood that FIG. 10 is provided for illustrative purposes only and is not intended to limit the scope of the disclosed embodiments, as modifications and variations will be apparent to those skilled in the art upon review of this description.

### Demand on SOC Analysts

Currently, Security Operations Centers (SOCs) are drowning in alerts. Every day, analysts are hit with thousands of alerts—each screaming for attention, most leading nowhere. Between EDR pings, email security events, identity anomalies, and SIEM noise, the reality is simple: no human team can investigate everything. Yet buried somewhere in that mountain of noise are perhaps ten alerts that actually matter. These ten alerts might point to lateral movement, credential abuse, persistence, exfiltration, or other attacks. If these are missing, it could result in a security breach. That is where AI changes the game.

Security teams are overwhelmed. In today's threat landscape, the average SOC faces thousands—sometimes tens of thousands—of alerts every day. Most of them are noise. A few may point to real threats. An unfortunate part of this reality is that they often look the same, and SOCs have reached a breaking point. It is no longer just about detecting threats—it is about knowing which ones to prioritize. That is where AI (e.g., the AI agent 150) can be beneficial.

SOCs were never designed to handle this level of volume. Tools like SIEMs, EDRs, and email security platforms fire off alerts in silos. Each alert might only represent a small part of the picture—an anomalous sign-in, a flagged URL, an unfamiliar process. But with traditional triage, these alerts are handled individually. Analysts manually pivot between consoles, check logs, and try to piece together a coherent story. It is slow. It is reactive. And it creates burnout. In many organizations, Tier 1 analysts spend most of their time on routine enrichment: checking IP reputation, user behavior, geolocation, and known device lists. But with thousands of alerts, manual triage is simply unsustainable. The result? Missed threats, alert fatigue, and high turnover.

Ironically, the more security tools a company adds, the worse alert fatigue gets. Every vendor produces alerts based on its own logic, often unaware of the broader context. This leads to duplicated signals, false positives, and blind spots in detection. Consider this common scenario: 1) An identity provider logs a suspicious sign-in. 2) Your EDR detects a suspicious PowerShell execution. 3) Your email filter flags a message with an obfuscated URL. Individually, none of these might escalate. But together, they could indicate credential theft, initial access, and command execution—the start of a breach. The problem? These alerts do not “talk” to each other. Your analysts are left to connect the dots manually—if they have time.

AI does not necessarily look at alerts in isolation. It can ingest signals across a stack—identity, EDR, email, cloud, network, and more—and automatically correlates them to build context. Think of AI as a virtual analyst that a) pulls in data from tools like Okta, Microsoft Defender, Proofpoint, and Sentinel, b) understands user behavior, device history, geo patterns, and past alert patterns, c) chains together related signals to build a narrative, and d) scores risk based on the entire event sequence, not just one alert. This is not just enrichment—it is storytelling. AI can build an attack timeline in seconds, whereas a human might spend hours correlating logs. AI also enables horizontal correlation: recognizing when multiple low-severity alerts across different users or endpoints share a common tactic, technique, or indicator. This level of insight is nearly impossible to achieve, at scale, without automation.

The real power of AI is not just speed—it is also consistency. While human analysts vary in skill, fatigue, and familiarity, AI applies the same rigorous logic every time. It does not skip steps. It does not miss signals buried three hops deep. Consider the following example: 1) A user logs in from a suspicious IP. 2) Minutes later, a script runs on their device. 3) Moments after this, the same user sends an unusual email to finance. AI correlates those events—across identity, endpoint, and email—and tags it as a coordinated incident. No swivel-chair analysis needed. AI also leverages statistical models and behavioral baselines. It knows what “normal” looks like for each user, device, and geo pattern—and flags deviations with supporting evidence. This eliminates the guesswork or human intuition.

Once AI has context, it can move from detection to decision. It can a) escalate high-confidence threats to analysts with full supporting evidence, b) suppress low-confidence noise without dropping true positives, c) trigger playbooks for containment—like quarantining emails, disabling sessions, or alerting users. This means your SOC is not buried in alerts. Instead, it is focused on verdicts—incidents that matter, backed by data, ready for action. AI also improves the feedback loop. As analysts review and disposition incidents, the AI learns from outcomes—refining its confidence thresholds and prioritization logic over time.

Therefore, AI agents, such as the AI agent 150 of FIG. 10, can be referred to as an AI SOC Analyst and can assist SOC professionals with investigating security threats. The AI SOC analyst integrates data from across the enterprise:
1) Identity Providers (Okta, Entra ID): login anomalies, geo risk, MFA abuse
2) Endpoint Detection & Response (Microsoft Defender, CrowdStrike): malware, lateral movement, persistence
3) Email Security (Proofpoint, Defender for Office 365): phishing links, spoofing, payload delivery
4) Cloud Logs & SIEMs (Sentinel, Splunk): session hijacking, privilege escalation, DLP

Each signal is valuable, but only in context. AI fuses them to detect patterns that humans miss—and filter out the noise that humans waste time chasing.

### Alert Report

FIG. 11 is an example of a screenshot of a user interface showing an SOC report 160 regarding an alert of a potential breach. The SOC report 160 can be produced by an AI agent (e.g., AI agent 150), an AI SOC Analyst, or other suitable threat analyzing system that can help SOC experts achieve breakthrough levels of investigation quality, speed, and coverage. It is possible to increase SOC investigation quality and speed with no additional headcount. The systems and methods herein can therefore use pre-trained AI (e.g., AI agent 150) applied to alerts derived from existing security tools. All alerts may be investigated by the systems and methods described in the present disclosure and can then produce an attestable investigation report (e.g., using the report generator 36) within minutes so SOC analysts can make decisions quickly, reduce MTTR, and focus on their most important work at hand.

### Knowledge Graph

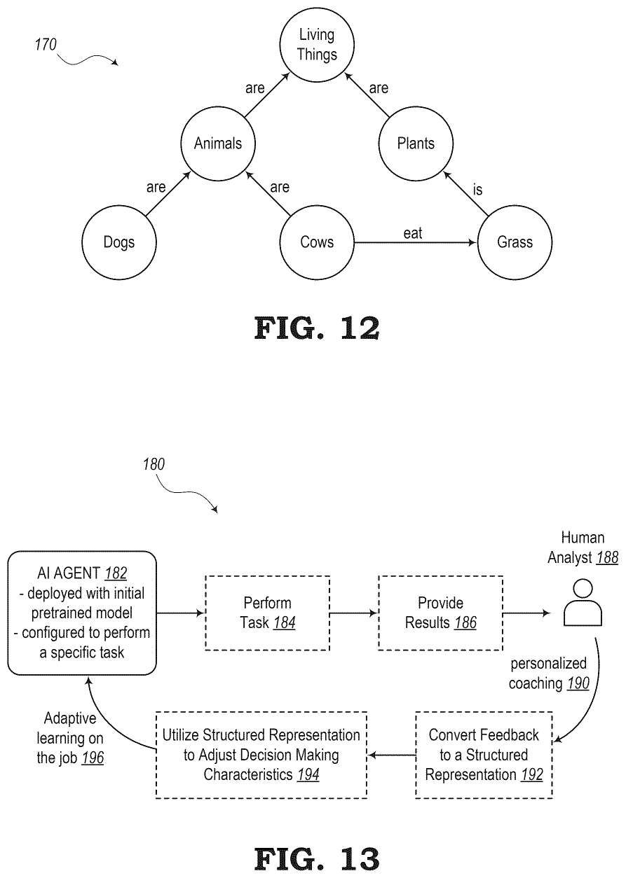

FIG. 12 is a diagram illustrating an example of a Knowledge Graph 170. In lieu of a large amount of textual data describing various entities or nodes, the Knowledge Graph 170 is designed to show the entities in a graphical form along with the relationships among the various entities or nodes. Thus, in FIG. 12, the circles of the Knowledge Graph 170 represent entities (e.g., “Living Things,” “Animals,” “Plants,” “Dogs,” etc.), while the edges (or straight lines) connecting the entities represent relationships between various pairs of entities. In this example, information can be communicated by the Knowledge Graph 170 that a) “Animals” and “Plants” are “Living Things,” b) “Dogs” and “Cows” are “Animals,” c) “Grass” is a type of “Plant,” and d) “Cow” eat “Grass.”

In various embodiments of the present disclosure, input from an SOC expert (e.g., cybersecurity analyst, network operator, admin, technician, etc.) can be translated, converted, or otherwise encoded to a structured representation, whereby the Knowledge Graph 170 is one example of such a structured representation. It may be understood that the various structured representations described herein may include structured knowledge graph or other graph-based representation having symbols and data for conveying certain information. Regarding the Knowledge Graph 170 of FIG. 12 and/or other various structured representations, it may be noted that information or data that is included therein can be utilized for various purposes. As described in the present disclosure, the systems and methods described herein may use knowledge graph reasoning or other types of symbolic reasoning to extract the graphic-based information to provide feedback to AI agents (e.g., AI agent 150) for modifying the functional characteristics of the AI agents, such as for changing how the AI agents make decisions. In some embodiments, the feedback to the AI agents allows the AI agents to adaptively learn on the job (e.g., adjust post-deployment behaviors).

In the context of cybersecurity, for example, input from an SOC expert may be provided as personalized coaching feedback. This coaching input can be represented in graphical from, such as in the Knowledge Graph 170. However, instead of reference to living things, the structured representation (e.g., knowledge graph) may include nodes related to other types of entities (e.g., users, user devices, IP addresses, organizations, security alerts, etc.) and edges related to other types of relationships (e.g., network access, telemetry information, etc.). The graphically presented representation can then be utilized as feedback provided to an AI agent, which may be configured to investigate security alerts. This input to the AI agent can adjust the AI agent during production to allow an adaptive learning-on-the-job process.

In the context of the present disclosure, a “symbol-based arrangement” refers to a structured representation in which the nodes and/or edges of a knowledge graph are labeled with abstract identifiers, tokens, or semantic symbols (e.g., alphanumeric strings, codes, or standardized indicators) that represent entities, attributes, or relationships in a manner independent of raw data formats. These symbols are intended to support symbolic reasoning, enabling the AI agent to process knowledge in terms of defined concepts and logical relationships rather than unstructured text. A symbol-based arrangement may be contrasted with purely data-driven or vector-based representations, as it encodes knowledge in a discrete, human-interpretable form suitable for logic-based inference.

A “tree-based arrangement” refers to a structured representation in which nodes are organized in a hierarchical, acyclic structure, where each node (except the root) has exactly one parent and may have zero or more child nodes. The hierarchy represents logical, causal, or categorical relationships among entities, enabling reasoning processes that follow a parent-to-child or child-to-parent traversal order. A tree-based arrangement may be used to model investigation steps, dependencies, or decision flows in a manner that ensures no circular references exist, thereby supporting efficient reasoning and divide-and-conquer strategies.

### Adaptive AI System

FIG. 13 is a diagram illustrating an embodiment of an adaptive system 180 that is configured to enable an AI agent 182 (e.g., AI agent 150) to be properly modified after initial deployment. Modification is intended to improve the functional accuracy of the AI agent 182 for performing a specific task. The AI agent 182 is originally deployed with a pretrained model and is configured, in particular, to perform the specific task. Again, in the context of security alert investigations, the AI agent 182 may be configured to use certain processes, techniques, algorithms, models, etc. to determine if an alert (suspected to indicate a security threat) is malicious or benign.

As shown in the embodiment of FIG. 13, the adaptive system 180 includes a procedure whereby the AI agent 182 performs a task (functional block element 184), such as the specific task that it is trained to do. In response to performing the task, results are provided (functional block element 186) to a human analyst 188. In this embodiment, the human-in-the-loop configuration allows for the checking of obvious errors and ensuring that artificial hallucinations are not part of the results. Thus, the human analyst 188 can provide personalized coaching 190, which may include any format of data or information for correcting or proofing the results or otherwise insert data that can be used for improving the accuracy or efficiency of the AI agent 182.

Next, the adaptive system 180 is configured to convert the feedback (e.g., personalized coaching 190) to a structured representation (functional block element 192). The structured representation, for example, may be a graphic representation similar to the structure shown in FIG. 12. Therefore, the adaptive system 180 is configured to translate the data extracted from the personalized coaching 190 input and encode it as a structured graph or other such representation. At this point, the adaptive system 180 is configured to utilize the structured representation to adjust various decision making characteristics (functional block element 194) of the AI agent 182. That is, the adaptive system 180 can provide instructions or control signals to the AI agent 182 to enact various adaptive learning on the job 196.

The functionality of the adaptive system 180 (e.g., functional block elements 184, 186, 192, 194) may be configured in software, in the memory 14, or in any suitable non-transitory computer-readable medium. In some embodiments, the functional block elements 184, 186, 192, 194 may be encoded as computer logic or processing instructions and/or may be part of the security threat investigation program 24 shown in FIG. 1. In some cases, the AI agent 182 may also be configured with these functional block elements within the memory 14.

Again, consider the context of utilizing an AI agent (e.g., AI agent 150, AI agent 182, etc.) in a system that investigates a number of security alerts in order to determine if the alerts are truly representative of a real threat or if they are actually indicative of benign traffic or activity. In such a system, the human analyst 188 may be a cybersecurity specialist, security expert, or the like. The personalized coaching 190 may be based on years of experience in the field of cybersecurity and may include knowledge of real threats. The adaptive learning on the job 196 may include recognizing that certain users may be travelling or may have been relocated, that certain IP addresses have been found to be malicious, or other such observations.

### Method of Utilizing a Structured Representation for Adaptive AI Learning

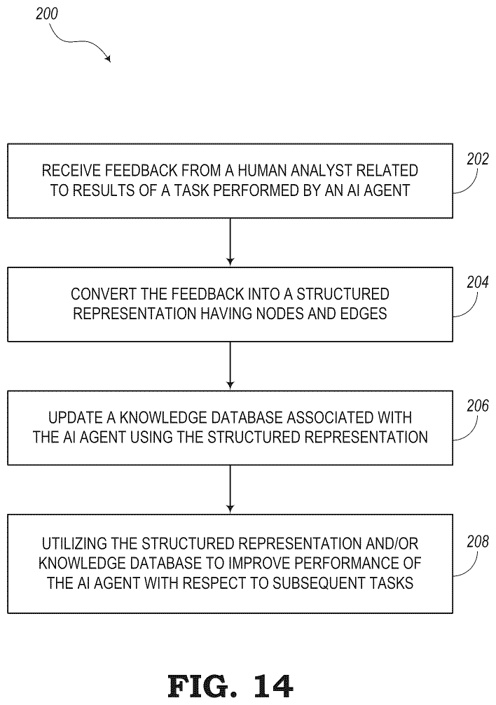

FIG. 14 is a flow diagram illustrating an embodiment of a method 200 for utilizing a structured representation in order to allow an AI agent to adaptively and continuously learn over time (e.g., “learning-on-the-job”). As shown in this embodiment, the method 200 includes a step of receiving feedback from a human analyst related to results of a task performed by an Artificial Intelligence (AI) agent, as indicated in block 202. The method 200 can include a step of converting the feedback into a structured representation having nodes and edges, as indicated in block 204. Also, the method 200 further includes a step of updating a knowledge database associated with the AI agent using the structured representation, as indicated in block 206. The method 200 can include a step of utilizing the structured representation and/or knowledge database to improve performance of the AI agent with respect to subsequent tasks, as indicated in block 208.

According to some embodiments, the structured representation may be a knowledge graph, wherein the nodes represent user identities, IP addresses, domain systems, and/or cybersecurity threat intelligence indicators, and wherein the edges represent relationships among the nodes including temporal, logical, and/or causal relationships. The AI agent, in some embodiments, may be configured to investigate one or more cybersecurity alerts to determine whether the one or more cybersecurity alerts are indicative of a real malicious threat or benign behavior. Also, the AI agent may originally be deployed with an initial pretrained model and may be configured for adaptive learning-on-the-job based on the structured representation.

In some implementations, the method 200 may further include a step of adjusting behavior of the AI agent in future tasks based on updating the knowledge database using a sample-efficient learning process. Also, according to some embodiments, the feedback may be configured as personalized coaching for improving the performance of the AI agent. Furthermore, the method 200, in some cases, may further include a step of performing structured reasoning, symbolic reasoning, and/or knowledge graph reasoning by applying first-order or second-order logic inference to the knowledge database. The structured representation, for example, may include company-specific nodes and cross-company relational nodes in a multi-tenant configuration.

In some embodiments, the method 200 may further include steps of a) dividing a task into subcomponents, and b) applying a divide-and-conquer strategy to investigate each subcomponent using knowledge in the structured representation. Additionally, the method 200 may include a step of performing an initial training of the AI agent using a bootstrapping dataset comprising labeled examples of historical cybersecurity alert investigations. Furthermore, the method 200 may also include steps of a) allowing the AI agent to investigate incoming security alerts by classifying each security alert as either benign or malicious based on contextual signals, and b) allowing the human analyst to provide feedback identifying whether a specific investigation outcome is correct or incorrect.

The method 200, in various implementations, may further include a step of applying a weighting scheme to conflicting signals in the knowledge database during a reasoning process, the weighting scheme prioritizing signals based on reliability and contextual relevance. Also, the method 200 may include steps of a) investigating Security Operations Center (SOC) or Security Information and Event Management (SIEM) alerts, and b) determining whether a user location anomaly is due to a legitimate virtual private network (VPN) or a potential attacker, based on Endpoint Detection and Response (EDR) signals. The AI agent, in some embodiments, may use symbolic reasoning to simulate human decision-making processes using logic-based knowledge encoded in the structured representation. Also, the structured representation may include a symbol-based or tree-based arrangement of nodes and edges.

### Benefits Over Conventional Systems

The present disclosure relates generally to artificial intelligence (AI) agents and, more particularly, to systems and methods for personalized feedback processing, efficient learning from feedback, and structured knowledge representation using knowledge graphs for improving AI agent performance across various domains, including but not limited to cybersecurity.

Conventional AI systems typically rely on large-scale supervised learning models or unsupervised learning methods that require substantial amounts of labeled training data to perform tasks effectively. These models often struggle with adapting to new situations or correcting themselves after deployment due to their limited capacity for real-time or sample-efficient learning.

Retrieval-Augmented Generation (RAG) is one conventional technique used to enhance Large Language Models (LLMs). In RAG systems, a language model retrieves relevant documents from a corpus and incorporates them into the prompt context. However, RAG approaches suffer from issues related to information chunk size, prompt token limitations, and ambiguity in how retrieved data is incorporated, often leading to hallucinations or inaccurate results.

Natural Language to SQL (text-to-SQL) systems are also known in the art and allow users to pose natural language questions that are translated into structured database queries. These systems provide utility but generally lack learning efficiency and adaptability to user-specific or context-specific feedback.

Traditional systems also lack structured knowledge representations to support symbolic or logical reasoning. Most rely on unstructured textual feedback, which is difficult for AI agents to process and learn from in a reliable and scalable manner.

The present disclosure introduces novel systems and methods for providing structured feedback to AI agents, enabling them to learn in a sample-efficient manner (e.g., from as little as one feedback example) and use the feedback to update structured knowledge representations such as knowledge graphs. This approach enables more accurate, personalized, and context-aware task execution and learning. Unlike conventional systems, the present disclosure integrates a dual-mode learning mechanism that combines (1) expert human coaching and (2) data-driven inference into a persistent, logical, and relational knowledge graph that can generalize across tasks, users, and enterprises.

The present disclosure relates to an AI feedback framework in which:
Feedback is gathered from domain experts (e.g., cybersecurity analysts) in textual or structured form.
Feedback is processed into structured formats, preferably as nodes and edges in a knowledge graph.
AI agents utilize this structured feedback in real-time to improve task performance, particularly in investigative or decision-making workflows (e.g., detecting malicious IPs or phishing attacks).
Learning is sample-efficient, often requiring just a single example to generalize a pattern, whereby sample efficiency may be defined as needing as few samples as possible (e.g., optimally just one sample) to create a generalized representations.
Knowledge graphs may be company-specific, cross-company, or multi-tenant, and can include hierarchical or relational logic (e.g., first-order, second-order, etc.).

In some embodiments, the AI agents (e.g., the AI agent 182 and/or other AI agents) are initialized via a bootstrapping process (e.g., bootcamp) and are configured to carry out tasks (e.g., monitoring logs, detecting anomalies). The systems of the present disclosure may include feedback input modules to receives feedback via the human analyst 188, such as a) concrete examples (e.g., “This IP should not be flagged.”), b) general instructions (e.g., “This VPN belongs to us.”), c) human-guided contextual corrections (e.g., chat-based supervision), and so on. The systems may also include feedback analysis engines that can a) identify types of feedback, b) classify feedback as procedural, corrective, confirmatory, or knowledge-based, c) convert the feedback into a structured graph, etc.

Additionally, the systems of the present disclosure may further include various knowledge graph generation modules and AI agent updating modules. The knowledge graph may be any suitable type of representation, graphical representation, etc. that represents knowledge in a graphical format. In some embodiments, this may include nodes (e.g., users, identities, IP addresses, actions, etc.) and edges (e.g., relationships, causalities, etc.). The structured representations may be organized into trees, hierarchies, relational graphs, of the like. Also, these graphical representations may support both first-order logic and second-order logic to model knowledge depth.

As such, the data from the structured representations can be extracted to perform adaptive functionality to tweak the AI agent 182 as needed to better analyze security alerts. Essentially, this allows the system to be an on-the-job (or post-deployment) system for allowing AI agents to be deployed and put into use, and then thereafter they can be modified on the fly to adjust to changing circumstances. The system can integrate new structured knowledge into the AI agent's operating model. This enables incremental learning during live operations. It also distinguishes between personalized (agent-specific) and general (reusable) knowledge.

In some embodiments, the systems of the present disclosure (e.g., the adaptive system 180) may be configured as or may be a part of a decision-making engine. For example, the decision-making engine may be configured to utilize the updated knowledge graph to improve reasoning and accuracy. Also, it can apply a divide-and-conquer approach to hypotheses (e.g., to prove or disprove IP maliciousness). Furthermore, it can adapt investigation strategies across dimensions (e.g., user behavior, geography, threat intelligence, ISP data, etc.).

Another aspect of the adaptive system 180 and/or other systems of the present disclosure is that knowledge may be compartmentalized for use by one organizational domain and/or may be universalized for use by global organizations. Furthermore, the adaptive measures to correct one AI agent may also be used to correct multiple AI agents. For instance, the systems herein may include cross-agent knowledge integration, which may promote individual agent graphs to broader company-wide or global graphs. Also, this may allow collaborative learning across agents and/or across multiple tenants.

In an example use case regarding a cybersecurity system, an AI agent may be configured to review a log showing login attempts from geographically distant IPs within a short timeframe. It may flag an alert for “impossible travel.” The human analyst 188 may verify that one IP is part of the company's VPN service and provides this feedback. This feedback is converted into a structured graph linking the user, IP, VPN provider, and company network, allowing the AI agent to correctly classify similar future alerts as benign.

It may further be noted that the systems described herein may avoid conventional RAG-based augmentation and instead use structured, symbolic knowledge to reason about alerts. This approach is not only more precise, but also it may avoid contextual drift or hallucinations associated with unstructured prompts.

The present disclosure is not necessarily just for security, but can basically be for any AI agent. It related to how we handle feedback. The feedback may be in a text format, where the systems and methods of the present disclosure can put the feedback in a knowledge graph format.

For example, there may be a user asking a natural language question, “How many IP addresses do I have in the past 10 days?”

Basically, the present disclosure can translate to a query and then queries the data. If you give the query to ChatGPT today, for example, it often makes mistakes. It will try and come up with these innovative ideas, where it provides additional information using Retrieval-Augmented Generation (RAG).

There are a lot of text-to-SQL systems (e.g., natural language query text to SQL) out there. It can be useful, but only if can successfully solve a problem and provide a proper answer to the query or prompt.

We focus on an additional step that we can take differently that makes the previous known solutions even better.

Using a RAG in the present application is probably not going to help, since we believe we have a better solution.

At a high level, consider agent feedback. Imagine any AI agent, not just a security AI agent, doing a task. The systems and methods of the present disclosure may be configured to download an original bootstrap, so the present disclosure lies beyond the original bootstrapping (or so-called bootcamp) aspect. So basically, the present systems have done this initial learning, and now they are ready to do the work.

Of course, at this point, its processing is not perfect. It will receive feedback. One feature of the present disclosure is how to handle this feedback. This can be related to sample efficiency, where, perhaps, one single example is enough to learn. For example, if we have an AI agent doing something (e.g., cybersecurity task, etc.). It might look at real-time logs. It receives a number of security alerts and then it must investigate these alerts. For example, alerts could be a phishing situation or maybe an alert regarding an impossible travel scenario.

There might be different types of mistakes an AI agent can make, and there are also different types of corrective activities it can receive. For example, the AI agents may be doing something, just like human beings. Imagine that a first person hires someone to write a patent application. Suppose they have done initial training and then do the work. The first person may then give feedback to make sure that they are doing things correctly and according to company policies. This can help the person do their job effectively. The systems and methods of the present disclosure may be similar, where they can give feedback or instructions about doing one thing like this and doing this other thing like that, and so on. You can also imagine that different people learn differently. The same thing is true with different types of AI agents. They can learn different ways based on how they are configured—for speech, logic, etc. For some of them, they might need more examples. Maybe one example is not enough. Or maybe, for instance, it could be even worse where they never learn.

These AI agents may be machine learning agents. In the past, there were a lot of customer complaints, which were fed as feedback telling them that they were wrong or inaccurate, but they were never able to improve. What we are talking about in the present disclosure is a learnable aspect. It might be learnable and also may be example efficient or sample efficient. You might only need one example to learn. So, the system can take that feedback, which might be concrete examples, that is the type of the knowledge it could be getting. In one sense, the feedback can essentially represent an inability to learn new knowledge. The system tries to break it down in terms of different types of knowledge.

The present disclosure is about how we give feedback to the AI agents and also how these AI agents take that feedback. Then, they should be able to absorb the knowledge and use it for future cases, so they can do these future tasks correctly.

The present disclosure can be any suitable combination of a) something that is done to the AI agent, and/or b) a process that is done with the AI agents. There is a process about how to teach the agent. Imagine scope scale AI that gathers all the training data. There is a process of how to gather feedback, such as during investigation (or analysis) of an alert (e.g., security alert). A human can look at a conclusion from the AI agent and then tell it what it should have been, what conclusion it should have drawn, or what it should have done. The human expert (network analyst) can provide this feedback through chat functionality to tell it why it was wrong. This knowledge is provided within that perspective, and in context.

Imagine this a different way. An IT expert might provide knowledge without a particular concrete case. He might just tell the AI agent, in a general case, “This VPN belongs to us; it is legit. This IP can be combined with this.” So may be different ways. The process of giving feedback might be based on concrete examples. This concept can be referred to herein as “personalized coaching.” It is kind of like supervised learning, but using direct instructions from a human expert.

Therefore, the AI agent can be given an initial task to operate within certain limitations, like a job description. It can be taught about any sorts of tasks, jobs, etc. In addition to this initial training, the AI agents can “learn-on-the-job.” It is personal coaching. One AI agent might make a mistake that others might not make. With on the job training or feedback, the AI agent can be more efficient.

Imagine a case where an AI agent might be in a “bootcamp” for a hundred days. In some respects, it might actually be able to learn all the same knowledge in one week with personalized coaching. That is what makes this learning process with an AI agent more efficient.

The systems and methods of the present disclosure use personalized coaching for the AI agents. An alternative way uses RAG to get additional knowledge, which is a legit way to provide knowledge, but it is not very efficient.

After the AI agent gets this feedback knowledge, it can put this info as a knowledge representation, which can be in text form or graph form. In this case, we can represent this more closely using a large graph. It makes a difference, because the info can be more consumable, because in the case of RAG, it is trying to match text. However, if RAG matches too small of a chunk of info or too large of a chunk, it can make more mistakes. The knowledge representation in a graph is better.

After this, the present disclosure is concerned with how to use this absorbed knowledge. The AI agent can use it for future investigations (if, of course, it is configured to investigate security alerts, such as in preferred embodiments). In a more general sense, the AI agent might basically be prepared to perform any future jobs while currently performing a similarly categorized job (based again on how it is configured).

Sample efficiency is also an important part of the present disclosure. It has an objective of efficiently performing a task with one (or few) samples, such as within this process of doing personalized coaching. Even with personalized coaching, some AI agents may tend to be faster than others at learning. One agent might get one example (sample) and learn, while another might need two or more examples. In an inefficient manner, another might need ten examples, which still might be more advantageous than previous attempts. The present disclosure has been demonstrated to still be more efficient. It takes fewer samples to learn.

In the context of the present disclosure (product and/or service), there is a person sitting there looking at an alert who can give accurate, precise, exact feedback.

With a quick initial training, the present disclosure allows just a small degree of mistakes. Big deal, so it is a mistake. For example (in the context of security alerts and investigating these alerts), the AI agent might initial think that something is malicious and might suggest, “This looks like a situation of impossible travel” or “This is the first time that this user is using a VPN” or “This is our call per rate VPN. If we see that, it is okay, but in this case, it is another type of VPN, which is suspicious.”

Also, we can handle knowledge that belongs to a particular company, customer, or client, which could be labeled as company-specific knowledge. Other knowledge might be general and can be used in a multi-tenant type of manner. The AI agent can apply this to future jobs as well and basically can be used across companies.

It can leverage EDR IP to figure out whether a user is travelling or if it represents a real attacker. This type of knowledge is something that can be learned, and then it can be applied for any companies.

With knowledge grab, it might have certain nodes regarding how to divide and conquer. And then, when you divide and conquer, at the end of the day, you need to combine them. It can be a bootstrap information thing to the next level in a hierarchy, which has more about how the present disclosure can combine this information.

The agent can get the IP information from a Single Sign-On (SSO) (e.g., from Okta) from a Zscaler IP. This info can say where the user who is doing something online is located (e.g., from an Endpoint Detection and Response (EDR) device in India). Instructions (feedback) can be provided to tell the AI agent to leverage the EDR IP (e.g., CrowdStrike IP). Why this matches might be because a user's laptop is used, where IP or laptop tells the present disclosure where the user is right now. For example, if the system sees a Hawaii IP, but the user's laptop says he or she is in Texas, this means that is he or she is still in Texas. The IP from Hawaii is more likely an attacker. So that is about info from an additional node.

There is a different type of knowledge that can be accumulated. The present disclosure may efficiently provide background knowledge, such as in a knowledge graph. Basically, it can have nodes (user, identity, IP address, other data) and edges (relationships). In some cases, it can be a tree. The graph can be a general graph. But during the investigation, the system can work on this graph to make it a tree.

To see whether an IP address is malicious or not, the system can look from different dimensions (e.g., the user who is using it, the company who is using it, the location of the user or company, ISP information, threat intel, etc.). The threat intel can be device, IP address, company, etc. The system can check by total, check the spur, the URL scan, and also very often it can find out who assesses information to determine if the IP is normal for this user and this company.

The system can also add a new node that, within a company, it can know how many users are using it. It can define the company environment. This might be a new node. And then again, at the end, it can figure out how to combine this different signal with other pieces of information. That is, in the context of a knowledge graph, the knowledge graph can provide a structured source of data that the AI agent can use to make a decision.

In some cases, the present disclosure might use divide and conquer as a hierarchy, but the key part is that, during investigation, it's more about a hypothesis, either to prove it's benign or to prove it's malicious (again, in the example of the AI agent being used in a system for investigating cybersecurity alerts regarding potentially malicious data). The system can divide and conquer; it can prove that the suspected content is malicious using different elements. For example, to prove an IP is malicious, if the threat tells it is malicious or it is abnormal for this user, or it is rarely used in this particular environment, the system can divide this into different signals and proceed from there to conquer the search for the truth about the hypothesis.

Text can make it harder for the AI agent to consume, so the present disclosure instead can use this knowledge representation in graphical form, which has a structure to make the reasoning easier, to be more accurate regarding the past.

Another way to look at this is that the human reasoning is symbolic or logical. In particular, this kind of information can be called first-order logic, but there can be more than just first-order.

The knowledge graph may be a relational graph. If, in the real graph, there is a different type of graph propositional logic, the 1st author of logic is more expressive because it abstracts and also introduces relations. The system can even introduce second order logic to make it more expressive, which means that it could even introduce a different type of knowledge, such as second order or even higher order knowledge. This kind of a logic can be encoded in the system.

They essentially can simulate the human way of reasoning, learning different types of knowledge. From a practical standpoint, the feedback aspect may be configured to add to that knowledge graph.

The system can have one cross-company graph and a whole company graph. Each company can have its own subgraph, but it is connected to the bigger graph. The system can promote certain small graphs to belong to the bigger graph.

One goal is to make sure the knowledge, the graph data, is as good as possible. The way this can be done is by using this feedback approach to update the graphs.

One method of the present disclosure is to take all of these different techniques to give feedback to the agent, to get the agent to do learning on the job.

Basically, any skill set where the AI agent does not initially do training, there is a way to get it to improve further. For example, the AI agent can describe how to control something. Plus, it will have a way to learn. This can be a contradictory tool that otherwise will have a human change the code to call the agent and to be able to do new things.

The conventional approach is usually the non-structured form, simply meaning the text. The knowledge graph of the present disclosure is a training of the LLM that is structured text, which in some respects may be a typical training but with structure data. The conventional systems can use RAG, since there is basically more text to the RAG. One way to ensure that more knowledge is being gained is by not using RAG. Thus, this translates to the present disclosure which promotes “learning on the job,” because humans are able to do it every day. Thus, the present disclosure is more effective and more efficient. Also, the systems and methods herein provide a better approach than the traditional one, which just gives it more text, either in a prompt or via RAG.

The present disclosure introduces the structure reasoning. Again, the knowledge graph described herein is structured. This essentially is structure learning as well.

Stated another way, one approach may include giving an LLM a large amount of prompt information and unstructured text. The LLM does not normally have this information in its language, but by giving structured feedback in the knowledge graph, the LLM can more effectively respond to a user's request.

Imagine that the more knowledge the LLM receives, the problem essentially gets longer and harder to solve. The more scenarios that are added, the more the unstructured data makes it break down in other ways. One way to break it down is to divide and conquer. And that is why the structure, the human-introduced logic and a lot of time, the graph described herein can actually reduce the complexity and help to make it easier to process.

In some embodiments, the AI agents may know that a case is benign, as determined in the past. Before doing the job, however, suppose that another component had done the job. Then, when asked to read those cases that were done beforehand, suppose the AI agents are not provided with that knowledge. Nevertheless, the AI agents can still leverage how it was being done before, in order to justify how the previous component did the work.

The present disclosure may also include a combination of two components. One component includes the explicit human feedback, which exploits the human's expertise or knowledge. Another component can be data driven. An analogy for this second data-driven component may be simple to a college student who uses old exams for studying. Even if the student does not understand how an answer is derived, he or she may still remember the answer. A new question in a new exam may be similar to a question in the old exam, and simply memorizing an answer can be helpful.

This may be a little bit more similar to doing unsupervised learning, especially since triggering false alarms today often trigger those same alarms tomorrow, unless the AI agents find a way to turn it off. Basically, that is the way the unsupervised learning has done a lot of the different workarounds. The AI agent can find a new way to accumulate the knowledge through the data, even though it is not explicitly abstracted to a knowledge which humans can verbalize. That is data that the AI agent can leverage. The effectiveness with this unsupervised learning algorithm is a key to making it effective. Other parts may be configured such that a sent attack could trigger multiple alerts.

In the past, imagine if each alert goes to different security analysts to investigate. Eventually they all come to the center—the same thing. If the systems and methods of the present disclosure were configured to group them together, they could figure out a way to make it easier and more thorough, like seeing different aspects of an elephant from different perspectives. When these different approaches are pieced together, the system can show one complete elephant.

Various grouping strategies can be used by the AI agents to piece together various datasets. In some cases, it may be determined that one piece is an anomaly and simply does not fit. Perhaps another piece fits, but because of certain issues (e.g., side effects), there is another piece that fits better.

### Summarization of the Novel Features of the Present Embodiments

Therefore, the systems and methods of the present disclosure are directed to learning-on-the-job AI agents with feedback from human experts for creating structured representations for knowledge graph or symbolic reasoning for follow-up investigation of security alerts for determining if the alerts are indicative of malicious or benign content.

One point of novelty of the systems and methods of the present disclosure lies in enabling AI agents to learn adaptively on the job through structured, personalized feedback encoded as a knowledge graph, rather than relying on traditional retraining or static fine-tuning approaches. The present disclosure describes systems and methods of continuously improving AI agent decision-making by converting concrete human feedback into structured graph-based knowledge, enabling sample-efficient learning and symbolic reasoning during live security alert investigations.

Thus, the embodiments described herein are considered to be novel with respect to conventional systems at least with respect to the following aspects:

1. Learning Beyond Initial Training (e.g., bootcamp)—Conventional systems rely on static bootstrapping or pretraining. The present disclosure enables agents to evolve through real-time, post-deployment learning—analogous to how humans improve with personalized coaching.

2. Structured Feedback via Knowledge Graphs—Feedback is not just stored as text or heuristics. It is converted into a knowledge graph, with nodes (e.g., users, IPs, VPNs) and relationships (e.g., access granted, known safe) to enable symbolic and relational reasoning. This contrasts with typical LLM prompt engineering or RAG approaches that use unstructured documents.

3. Sample-Efficient and Personalized Learning—The present systems support learning from as little as one example, with adaptive retention depending on the agent's characteristics. Some agents may require repeated examples; while others generalize quickly. This per-agent learning adaptability mimics real-world coaching and is not found in generic AI pipelines.

4. Dual-Scope Knowledge Integration—The present disclosure supports both a) Organization-specific knowledge (e.g., PAN GlobalProtect VPN is safe in Company A), and b) Cross-organization generalizations (e.g., use of CrowdStrike EDR IP to validate geolocation). Graph structure allows promotion of private insights to global rules when appropriate—a multi-tenant knowledge architecture.

5. Symbolic Reasoning via First-Order or Higher-Order Logic-Unlike black-box pattern matching, the present systems enable logic-based decision-making over relationships (e.g., “User A created access for User B from a suspicious IP” can be modeled as first-order logic). Also, the present systems support relational graphs, unlike propositional logic-based or vector-only systems.

That is, the systems and methods of the present disclosure introduce a feedback-driven, structured learning architecture for AI agents that a) mimics human coaching, b) leverages symbolic reasoning over graphs, c) supports multi-tenant contextualization, and d) improves accuracy with fewer training samples. The present systems offer a scalable, explainable, and customizable approach to continuous AI improvement in high-stakes environments like cybersecurity.

The present disclosure may be configured a system with Adaptive Learning AI for Security Alert Investigations. This may involve AI agents used in security alert investigations. Also, this may include innovations around feedback-driven, structured learning for these agents, particularly beyond initial bootstrapping or training.

In some embodiments, the present disclosure may center on learning-on-the-job AI agents that continuously improve during real-world operation. This may be done by a) receiving personalized feedback from human analysts, b) structuring that feedback into graph-based knowledge representations, and c) using symbolic and logical reasoning over the graph to make future decisions more accurately and efficiently. These innovations make AI agents sample-efficient, requiring only one or a few examples to learn from feedback, much like a human with personalized coaching.

Again, the systems and methods of the present disclosure may include many Key Concepts and Technical Innovations, such as:

1. Feedback as Structured Knowledge—Feedback provided by human analysts (e.g., correcting alert conclusions) is translated into structured knowledge. This structured knowledge is stored in a knowledge graph, where nodes represent entities (e.g., IPs, users) and edges represent relationships (e.g., access created, VPN source). The structure allows for more robust and symbolic reasoning (e.g., using first-order logic), in contrast to conventional prompt engineering or RAG (retrieval-augmented generation) that operates on unstructured text.

2. Personalized Coaching and Sample-Efficient Learning—Unlike generic LLM fine-tuning, the AI agent adapts through targeted, personalized feedback. Feedback is contextualized based on specific investigations and allows the AI to quickly incorporate learnings. Agents may vary in learning speed (some may generalize from one example, others need multiple), and the system tracks this.

3. Graph Reasoning for Decision Support—The AI agent uses structured graph reasoning, often simulating human-like symbolic logic. Investigations follow a divide-and-conquer model represented as subtrees of a broader knowledge graph. Graphs, for example, may include both: a) Company-specific subgraphs (institutional knowledge like internal VPN IPs), and b) Cross-company knowledge (generalized patterns, like attacker behavior via EDR signals).

4. Types of Knowledge and Their Application—Institutional knowledge (e.g., a VPN being company-owned) is useful only for the originating organization. Cross-tenant knowledge (e.g., CrowdStrike EDR IP confirming location) can apply across customers. The system determines what type of knowledge is extracted and how it is used in subsequent investigations.

5. Knowledge Promotion and Representation—Knowledge can be promoted from a company-specific graph to the global graph if deemed generalizable. The reasoning engine can handle first-order and potentially higher-order logic, offering greater expressiveness and precision in decision-making.

Furthermore, various potential use cases may be applicable for use with the AI SOC Analysts systems and methods discussed herein. For example, for investigating potential threat alerts, the present disclosure may be applied for:
1. Investigating phishing or impossible travel alerts,
2. Distinguishing between legitimate and suspicious VPN usage based on contextual knowledge,
3. Using EDR/IP correlation to distinguish real users from attackers, and
4. Learning which behaviors are company-specific vs. globally applicable

### CONCLUSION

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. Additionally, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

What is claimed is:

1. A method comprising steps of:
receiving feedback from a human analyst related to results of a task performed by an Artificial Intelligence (AI) agent;
converting the feedback into a structured representation having nodes and edges;
updating a knowledge database associated with the AI agent using the structured representation; and
utilizing the structured representation and/or knowledge database to improve performance of the AI agent with respect to subsequent tasks.

2. The method of claim 1, wherein the structured representation is any of a knowledge graph in which nodes represent user identities, IP addresses, domain systems, and/or cybersecurity threat intelligence indicators, and edges represent relationships among the nodes, the relationships including temporal, logical, and/or causal relationships; and
logic programs extending first-order logic (FOL), the logic programs comprising sets of logical statements including facts and rules that describe knowledge about a domain to enable automated reasoning and inference.

3. The method of claim 1, wherein the AI agent is configured to investigate one or more cybersecurity alerts to determine whether the one or more cybersecurity alerts are indicative of a real malicious threat or benign behavior.

4. The method of claim 1, wherein the AI agent is originally deployed with an initial pretrained model and is configured for adaptive learning-on-the-job based on the structured representation.

5. The method of claim 1, further comprising a step of adjusting behavior of the AI agent in future tasks based on updating the knowledge database using a sample-efficient learning process.

6. The method of claim 1, wherein the feedback is configured as personalized coaching for improving the performance of the AI agent.

7. The method of claim 1, further comprising a step of performing structured reasoning, symbolic reasoning, and/or knowledge graph reasoning by applying first-order or second-order logic inference to the knowledge database.

8. The method of claim 1, wherein the structured representation includes company-specific nodes and cross-company relational nodes in a multi-tenant configuration.

9. The method of claim 1, further comprising steps of:
dividing a task into subcomponents; and
applying a divide-and-conquer strategy to investigate each subcomponent using knowledge in the structured representation.

10. The method of claim 1, further comprising a step of performing an initial training of the AI agent using a bootstrapping dataset comprising labeled examples of historical cybersecurity alert investigations.

11. The method of claim 1, further comprising steps of:
allowing the AI agent to investigate incoming security alerts by classifying each security alert as either benign or malicious based on contextual signals; and
allowing the human analyst to provide feedback identifying whether a specific investigation outcome is correct or incorrect.

12. The method of claim 1, further comprising a step of applying a weighting scheme to conflicting signals in the knowledge database during a reasoning process, the weighting scheme prioritizing signals based on reliability and contextual relevance.

13. The method of claim 1, further comprising steps of:
investigating Security Operations Center (SOC) or Security Information and Event Management (SIEM) alerts; and
determining whether a user location anomaly is due to a legitimate virtual private network (VPN) or a potential attacker, based on Endpoint Detection and Response (EDR) signals.

14. The method of claim 1, wherein the AI agent uses symbolic reasoning to simulate human decision-making processes using logic-based knowledge encoded in the structured representation.

15. The method of claim 1, wherein the structured representation includes a symbol-based or tree-based arrangement of nodes and edges.

16. A Security Operations Center (SOC) computing system comprising:
a processing device; and
memory configured to store a security threat investigation program having logic instructions for enabling the processing device to perform steps of:
receiving feedback from a human analyst related to results of a task performed by an Artificial Intelligence (AI) agent;
converting the feedback into a structured representation having nodes and edges;
updating a knowledge database associated with the AI agent using the structured representation; and
utilizing the structured representation and/or knowledge database to improve performance of the AI agent with respect to subsequent tasks.

17. The SOC computing system of claim 16, wherein the structured representation is any of
a knowledge graph in which nodes represent user identities, IP addresses, domain systems, and/or cybersecurity threat intelligence indicators, and edges represent relationships among the nodes, the relationships including temporal, logical, and/or causal relationships; and
logic programs extending first-order logic (FOL), the logic programs comprising sets of logical statements including facts and rules that describe knowledge about a domain to enable automated reasoning and inference.

18. The SOC computing system of claim 16, wherein the AI agent is configured to investigate one or more cybersecurity alerts to determine whether each of the one or more cybersecurity alerts is indicative of a real malicious threat or benign behavior.

19. A non-transitory computer-readable medium configured to store computing logic having instructions that cause one or more processing devices to perform steps of:
receiving feedback from a human analyst related to results of a task performed by an Artificial Intelligence (AI) agent;
converting the feedback into a structured representation having nodes and edges;
updating a knowledge database associated with the AI agent using the structured representation; and
utilizing the structured representation and/or knowledge database to improve performance of the AI agent with respect to subsequent tasks.

20. The non-transitory computer-readable medium of claim 19, wherein the AI agent is originally deployed with an initial pretrained model, and wherein the instructions further cause the one or more processing devices to adjust behavior of the AI agent in future tasks based on updating the knowledge database using a sample-efficient learning process to enable adaptive learning-on-the-job.
